(19) United States
(12) Patent Application Publication
(10) Pub. No.: US 2013/0301113 A1
(43) Pub. Date: Nov. 14, 2013

(54) DEFORMABLE MIRRORS AND METHODS OF MAKING THE SAME

(71) Applicant: California Institute of Technology, Pasadena, CA (US)

(72) Inventors: Sergio Pellegrino, Pasadena, CA (US); Keith D. Patterson, Los Angeles, CA (US); Chiara Daraio, Pasadena, CA (US); Eleftherios Gdoutos, Pasadena, CA (US); Namiko Yamamoto, Pasadena, CA (US); Risaku Toda, Pasadena, CA (US); Victor E. White, Altadena, CA (US); Harish Manohara, Arcadia, CA (US); John B. Steeves, Pasadena, CA (US)

(21) Appl. No.: 13/865,179

(22) Filed: Apr. 17, 2013

Related U.S. Application Data
(60) Provisional application No. 61/625,542, filed on Apr. 17, 2012.
(60) Provisional application No. 61/665,142, filed on Jun. 27, 2012.

(51) Int. Cl. G02B 26/08

(52) U.S. Cl. CPC G02B 26/08
USPC 359/298; 427/100

(57) ABSTRACT

A deformable mirror is configured to be deformed by surface-parallel actuation. In one embodiment, the deformable mirror includes a first piezoelectric active layer on a first surface of a substrate. The first piezoelectric active layer has a substantially uniform thickness across the first surface of the substrate. The mirror also includes a first electrode layer on the first piezoelectric active layer. The first electrode layer has a plurality of electrodes arranged in a first pattern and has a substantially uniform thickness across the first piezoelectric active layer. The mirror may further include a second piezoelectric layer on the first electrode layer, and a second electrode layer on the second piezoelectric layer. The electrodes of the first and second electrode layers are configured to supply a voltage to the piezoelectric active layers upon actuation to thereby locally deform the shape of the mirror to correct for optical aberrations.

### CROSS-REFERENCE TO RELATED APPLICATIONS

This application claims priority to and the benefit of U.S. Provisional Application No. 61/665,142, filed Jun. 27, 2012, and U.S. Provisional Application No. 61/625,542, filed Apr. 17, 2012, the entire contents of both of which are incorporated herein by reference.

### STATEMENT REGARDING FEDERALLY SPONSORED RESEARCH OR DEVELOPMENT

The invention described herein was made in the performance of work under a NASA contract, and is subject to the provisions of Public Law 96-517 (35 U.S.C. §202) in which the Contractor has elected to retain title.

### TECHNICAL FIELD

The present disclosure relates to thin, lightweight deformable mirrors.

### BACKGROUND

Large, monolithic mirrors have been utilized in various optical applications, such as space-based telescopes. However, large monolithic mirrors tend to be prohibitively heavy and expensive. Accordingly, segmented mirrors containing an array of smaller mirrors have been devised. For instance, these mirror segments may be assembled autonomously in orbit in order to achieve a large aperture segmented primary mirror for a space telescope. However, segmented mirrors are susceptible to curvature errors across the array. Accordingly, deformable mirrors have been developed to correct for the curvature error across the segmented mirror array.

Conventional deformable mirrors use a series of actuators to deform the different segments of the mirror. Several different configurations of the actuators are possible, such as (1) surface-normal actuation; (2) surface-parallel actuation; and (3) boundary actuation. In surface-normal actuation, an array of piston actuators alternately push and pull on the mirror surface to produce localized deformations (i.e., protrusions and recesses). In surface-parallel actuation, actuators attached to a mirror facesheet bend the mirror. In boundary actuation, actuators disposed around the periphery of the mirror (i.e., the rim) apply forces and/or torques to produce deformations of the mirror. However, boundary actuation type deformable mirrors are only able to achieve a limited range of deformation modes of the mirror. Additionally, conventional surface-normal and surface-parallel actuation type deformable minors are limited in size and are not easily scalable to larger diameters due to the large number of actuators, and corresponding actuator strokes, required to deform the mirror. Moreover, conventional surface-parallel type deformable mirrors have a stiff backing structure, which both limits the deformability of the mirror and increases the overall weight of the mirror.

### SUMMARY

The present application is directed to various embodiments of lightweight, deformable mirrors. In one embodiment, the deformable mirror includes a substrate having a first surface and a second surface opposite the first surface. In one embodiment, the first surface is an inner surface facing away from an incident light source and the second surface is an outer surface facing toward the incident light source. A first piezoelectric active layer having a substantially uniform thickness is deposited on the first surface of the substrate. A first electrode layer having a plurality of electrodes arranged in a first pattern is deposited on the first piezoelectric active layer. The electrodes are configured to supply a voltage to the piezoelectric active layer to deform the shape of the mirror to correct for optical aberrations. The electrode pattern may include a plurality of rectangular electrodes arranged in a triangular lattice pattern, a plurality of tessellated hexagonal electrodes, or a plurality of semi-annular electrodes disposed in a pattern of concentric rings. The deformable mirror also includes a reflective coating coupled to the outer surface of the substrate and a grounding layer disposed between the substrate and the first active layer.

In one embodiment, the deformable mirror also includes a second piezoelectric active layer deposited on the first electrode layer and a second electrode layer having a plurality of electrodes arranged in a second pattern deposited on the second piezoelectric active layer. The first pattern of electrodes on the first electrode layer may be different than the second pattern of electrodes on the second electrode layer.

In one embodiment, the deformable mirror may include a thermal balancing layer deposited on the first surface of the substrate. The thermal balancing layer is configured to thermally balance the deformable mirror.

The deformable mirror may also include a microcontroller electrically coupled to the plurality of electrodes on the first and second electrode layers. Each electrode in each pattern is individually addressable by the microcontroller.

The deformable mirror may also include a stiffening rim coupled to a periphery of the substrate. The stiffening rim is configured to maintain the substrate in a curved shape beyond a buckle limit of the substrate. In one embodiment, a series of actuators may be provided on the stiffening rim such that the periphery of the deformable mirror can be deformed.

The substrate may be made of silicon, silicon carbide, glass, carbon fiber, aluminum, steel, or beryllium.

The active layers may include any suitable piezoelectric material, for example, piezoelectric polymers, piezoelectric ceramics, electrostrictive materials, dielectric elastomers, or magnetostrictives.

The present application is also directed to various methods of manufacturing a deformable mirror. In one embodiment, the method includes depositing a first active layer having a substantially uniform thickness on a second surface of a substrate. The method also includes depositing a first electrode layer on the first active layer. In one embodiment, depositing the first active layer includes spin-coating a copolymer resin on an inner surface of the substrate. In another embodiment, depositing the first active layer includes adhering a sheet of polymer to an inner surface of the substrate. In one embodiment, depositing the first electrode layer includes physical vapor deposition of a of an electrode material on the first active layer. In one embodiment, depositing the first electrode layer includes pattern deposition, for example, patterned photolithography using a photoresist, patterned electron-beam lithography using a resist, or sputtering using a physical shadow mask. The patterned electrode layer may include rectangular electrodes arranged in a triangular lattice, tessellated hexagonal electrodes, or semi-annular electrodes arranged in a pattern of concentric rings. In one embodiment, the method includes poling the active layer to impart piezoelectric properties to the active layer. In another embodiment, the method includes etching the substrate to expose at least a portion of the first active layer and depositing a reflective layer on the exposed portion of the first active layer.

In one embodiment, the method includes depositing a second piezoelectric layer on the first electrode layer and depositing a second electrode layer on the second piezoelectric layer.

This summary is provided to introduce a selection of concepts that are further described below in the detailed description. This summary is not intended to identify key or essential features of the claimed subject matter, nor is it intended to be used in limiting the scope of the claimed subject matter.

### BRIEF DESCRIPTION OF THE DRAWINGS

These and other features and advantages of embodiments of the present invention will become more apparent by reference to the following detailed description when considered in conjunction with the following drawings. In the drawings, like reference numerals are used throughout the figures to reference like features and components. The figures are not necessarily drawn to scale. Additionally, the patent or application file contains at least one drawing executed in color. Copies of this patent or patent application publication with color drawing(s) will be provided by the Office upon request and payment of the necessary fee.

FIG. 1A is an exploded perspective view of a deformable mirror according to one embodiment of the present application;

FIG. 1B is an assembled perspective view of the deformable mirror illustrated in FIG. 1A;

FIG. 2 is a plot illustrating the deformations that can be achieved using a substrate having various thicknesses and elastic moduli;

FIGS. 3A-3C are top views of various embodiments of an electrode layer having a plurality of electrodes arranged in a triangular lattice pattern;

FIGS. 4A-4C are top views of various embodiments of an electrode layer having a plurality of electrodes arranged in a hexagonal tessellation pattern;

FIG. 5A is a plot illustrating the ability of each of the electrode layers illustrated in FIGS. 3A-4C to correct for optical aberrations represented by the first thirty Zernike modes;

FIG. 5B is a plot illustrating the general relationship between residual and input error in any chosen mode;

FIGS. 6A-6C are plots illustrating the ability of each electrode layer illustrated in FIGS. 3A-4C to correct for a defocus aberration in the mirror, an astigmatism aberration in the mirror, and a coma aberration in the mirror, respectively;

FIG. 7 is a schematic illustration of a control system configured to drive the electrodes on the electrode layers;

FIG. 8 is a flowchart illustrating a method of manufacturing a deformable mirror according to one embodiment of the present application;

FIG. 9 is a flowchart illustrating a method of manufacturing a deformable mirror according to another embodiment of the present application;

FIGS. 10A-10D illustrate different stages of an etching process during a method of manufacturing a deformable mirror according to one embodiment of the present application;

FIGS. 11A and 11B illustrate different stages of a water delamination process during a method of manufacturing a deformable mirror according to one embodiment of the present application;

FIG. 12 illustrates a deformable mirror stacked on a mold, and a sacrificial layer configured to be dissolved in a solvent to separate the deformable mirror from the mold during a method of manufacturing the deformable mirror according to one embodiment of the present application;

FIGS. 13A-13D illustrate the center displacement, curvature, radius of curvature, and strain, respectively, of a deformable mirror during a poling process according to one embodiment of the present application;

FIGS. 14A-14D illustrate the center displacement, curvature, radius of curvature, and strain, respectively, of the deformable mirror of FIGS. 13A-13D after it has been poled;

FIG. 15 is a schematic illustration of an optical measurement setup configured to measure the shape of a deformable mirror according to one embodiment of the present invention;

FIGS. 16A and 16B illustrate the measured, individual influence functions from various channels of a deformable mirror according to one embodiment of the present invention and corresponding predictions obtained from a finite element model, respectively;

FIG. 17 is a plot illustrating the ability of a deformable mirror according to one embodiment of the present application to correct for a defocus aberration in the mirror; and

FIG. 18 is a plot illustrating the reduction in root-mean-square shape error in a deformable mirror according to one embodiment of the present application.

### DETAILED DESCRIPTION

The present application is directed to thin, lightweight deformable mirrors configured to be deformed by surface-parallel actuation to correct for various optical aberrations. Additionally, the deformable mirrors of the present application are configured to compensate for thermally induced distortion and long-term material effects, such as creep and aging (i.e., the deformable mirrors are configured to have a low composite coefficient of thermal expansion). The thin, lightweight deformable mirrors of the present application are also configured to be scaled to larger diameters (or other size dimensions) than conventional deformable mirrors, such as approximately 50 cm to approximately 0.5m, due in part to the layer-on-layer deposition manufacturing methods described below and the relatively low areal mass density of the deformable mirrors, such as approximately 0.5 kg/m². The deformable mirrors of the present application have a sufficiently large shape correction dynamic range to allow the same base design to be used for all of the mirrors in a segmented primary mirror.

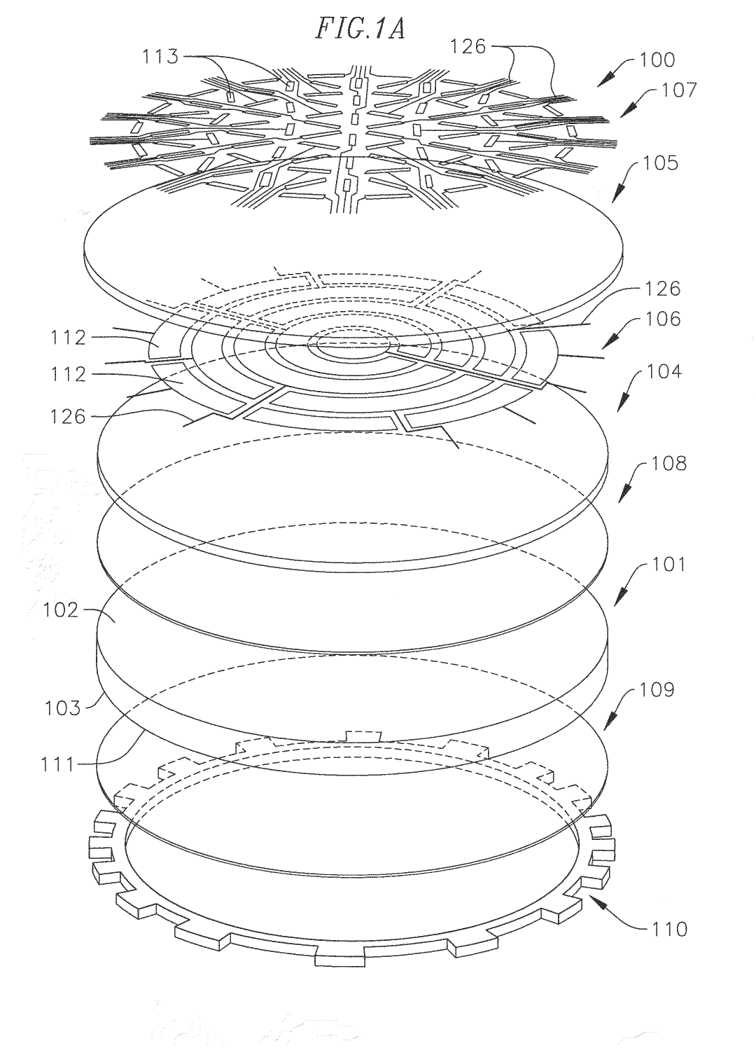

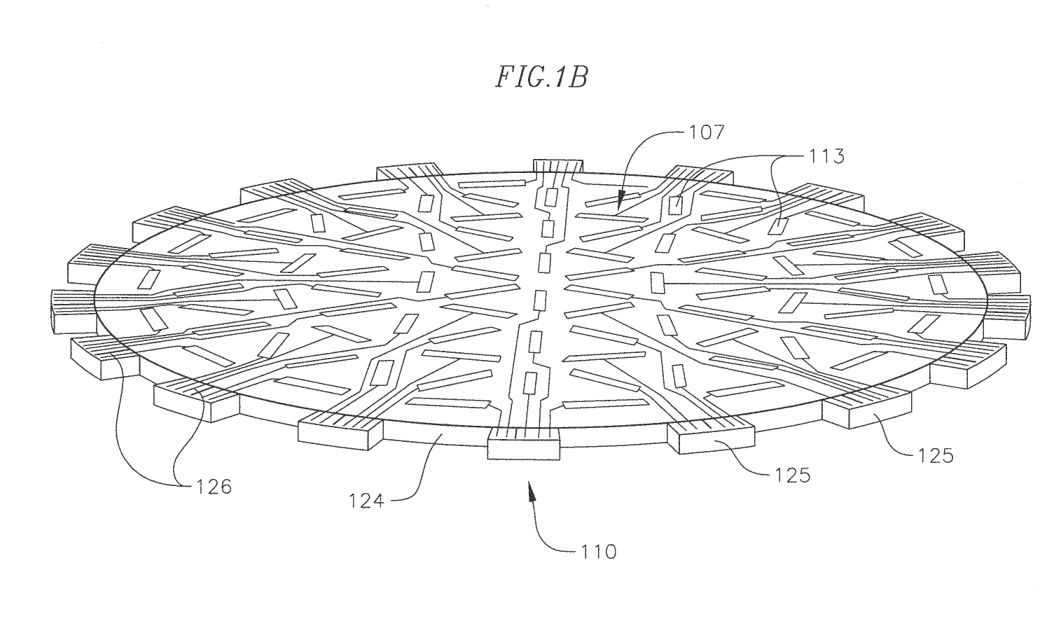

With reference now to the exploded view of FIG. 1A, an embodiment of a deformable mirror 100 is illustrated. The deformable mirror 100 includes a substrate 101 having first and second surfaces 102, 103, respectively. In one embodiment, the first surface is an inner surface 102 facing away from an incident light source and the second surface is an outer surface 103 facing toward the incident light source. The deformable mirror 100 also includes a first active layer 104 deposited on the inner surface 102 of the substrate 101 and a first electrode layer 106 deposited on the first active layer 104. The deformable mirror 100 further includes a ground layer 108 coupled to the inner surface 102 of the substrate 101, and a reflective layer 109 coupled to the outer surface 103 of the substrate 101. The reflective layer 109 is the optical surface of the deformable mirror 100 and is configured to reflect incident light.

The electrode layer 106 includes a plurality of individually addressable electrodes 112. The electrode layer 106 is configured to drive the active layer 104 by supplying a voltage across the active layer 104. When actuated by the electrode layer 106, the active layer 104 is configured to deform the shape of the reflective layer 109 by supplying surface-parallel actuation to the surface of the reflective layer 109 (i.e., the electrode layer 106 and the active layer 104 produce in-plane strains to deform the reflective layer 109). Additionally, the electrodes 112 on the electrode layer 106 are individually actuatable or addressable such that the electrode layer 106 can locally deform the reflective layer 109 in only the localized areas of the actuated electrodes 112. In the illustrated embodiment of FIG. 1A, the deformable mirror 100 includes first and second active layers 104, 105, respectively, and first and second electrode layers 106, 107, respectively, alternately stacked on the inner surface 102 of the substrate 101. Providing first and second active layers 104, 105 and first and second electrode layers 106, 107 is configured to provide greater control over deforming the shape of the mirror 100 to correct for optical aberrations.

The reflective layer 109, which is provided on the outer surface 103 of the substrate 101, may be formed from any material having a suitably high reflectance value for a given wavelength spectrum the mirror 100 is configured to reflect (e.g., visible or infrared wavelengths). For example, the reflective layer may be made of a metal, such as aluminum, silver, gold, or combinations thereof. The reflective layer 109 may have any suitable thickness, for example, approximately 0.1 microns to approximately 5 microns. In one embodiment, a transparent ceramic oxide layer may be provided over the reflective layer 109. When the reflective layer 109 is made from a soft metal, the transparent ceramic oxide layer may be provided to protect the reflective layer from damage. When the reflective layer 109 is made from an oxidizable metal (e.g., aluminum or silver), the transparent ceramic oxide layer may be provided to prevent oxidation of the reflective layer 109. The transparent ceramic oxide layer may be formed on the reflective layer 109 by any suitable method, such as physical vapor deposition (e.g., vacuum sputtering or thermal evaporation). The thickness of the transparent ceramic oxide layer may be selected to achieve a suitably high reflectivity for a given wavelength spectrum. In one embodiment, the transparent ceramic oxide layer may have a thickness of approximately 200 nm. In an alternate embodiment, the deformable mirror 100 may be provided without the separately deposited (or stacked) reflective layer 109, and the outer surface 103 of the substrate 101 may be polished to achieve a reflective surface (e.g., by polishing the second (or outer) surface of the substrate, which may be made of silicon, for example).

The substrate 101 aids in shape retention of the deformable mirror 100 without complex mounting fixtures, and provides an initial shape for the deformable mirror 100 that is close to the desired optical shape. The substrate 101 may be formed of any suitable material having a relatively high extensional stiffness and a relatively low bending stiffness to facilitate a large range of curvature changes, such as silicon (Si), silicon carbide (SiC), glass (e.g., FS, BK7, borosilicate, lithium aluminosilicate glass-ceramic), carbon fiber composites, or metal (e.g., aluminum, steel, or beryllium). As used herein, the term “metal” refers to base metals, metal alloys, ferrous and non-ferrous metals, noble metals, precious metals, and alkaline earth metals. The substrate 101 may have any suitable extensional stiffness, such as, for example, approximately 20 GPa to approximately 200 GPa, and any suitable bending stiffness, such as, for example, approximately 0.01 N-m to approximately 1 N-m. The substrate 101 may have any suitable thickness, such as, for example, approximately 50 microns to approximately 1000 microns, and any suitable diameter (or other size dimension), such as, for example approximately 50 mm to approximately 500 mm. In one embodiment, for example, the substrate 101 has a diameter of approximately 100 mm and a thickness of approximately 200 microns. In one embodiment, the substrate 101 also has a low surface roughness, such as approximately 1 nm to approximately 5 nm. In another embodiment, the substrate 101 material may be polished to an optical quality finish. Additionally, the substrate 101 material may have high thermal conductivity to prevent thermal gradients from distorting the shape of the deformable mirror 100. For instance, a glass substrate 101 may have a thermal conductivity of approximately 1 W/m-k, and a silicon substrate 101 may have a thermal conductivity of approximately 150 W/m-k.

When the active layer 104 is substantially thinner than the substrate 101 (e.g., a 20 microns thick active layer 104 and a 200 microns thick substrate 101), the achievable deformations, k, of the substrate 101 can be estimated using Stoney's formula,

$$k = \frac{6 {ɛ}_{a} {M}_{a} {t}_{a}}{{t}_{s}^{2} {M}_{s}} = \frac{6 {σ}_{a} {t}_{a}}{{t}_{s}^{2} {M}_{s}} ,$$

where εₐ is the actuation strain, tₛ and tₐ are the thicknesses of the substrate 101 and the active layer 104, respectively, and Mₛ and Mₐ are the biaxial moduli of the substrate 101 and the active layer 104, respectively. The biaxial blocked stress, σₐ=εₐMₐ, may be used in place of the actuation strain, εₐ. For an isotropic material, the biaxial modulus is

$$\frac{E}{1} - υ ,$$

where E is Young's modulus and ν is Poisson's ratio. In order to increase the achievable deformations k, of the substrate 101 without changing the blocked stress, the substrate thickness may be reduced or a softer substrate material may be chosen. However, there are certain practical limits to the thickness and elastic modulus of the substrate 101. For instance, in embodiments in which the active layer 104 is poled to impart piezoelectric properties to the active layer 104, described in more detail below, a residual poling strain, εₚ, will remain on the substrate 101 due to the permanent reorientation of the dipole domains within the substrate material. The substrate 101 may buckle into a cylindrical mode if the residual poling strain, εₚ, exceeds a critical limit. The minimum (or critical) thickness, t_{crit}, at the onset of buckling of a circular plate of radius R is defined as follows:

$${t}_{crit} \approx {( \frac{1.05 {ɛ}_{p} {M}_{a} {t}_{a} {R}^{2}}{{M}_{s}} )}^{1 / 3} .$$

FIG. 2 illustrates the achievable deformations, according to Stoney's formula, for substrates 101 having an elastic modulus ranging from 50 GPa to 200 GPa and a thickness ranging between 100 microns and 300 microns when deformed by a single active layer 104 of P(VDF-TrFE) having a thickness of 20 microns. As shown in FIG. 2, the thickness and elastic modulus of the substrate 101 determines the achievable deformations of the substrate 101. For instance, a silicon substrate 101 having a thickness of approximately 200 microns and an elastic modulus of approximately 180 GPa is configured to be deformed by approximately 1000 microns. Accordingly, the appropriate substrate 101 material and thickness can be selected based upon the desired range of deformations achievable by the deformable mirror 100 (i.e., the desired deformation performance of the resulting mirror 100 can be tuned by adjusting the thickness of the substrate 101 and/or by selecting a substrate material with a different elastic modulus). According to the buckling formula presented above, the lower solid line in FIG. 2 represents the theoretical lower limit at which a substrate 101 having a 50 mm radius would buckle into a cylindrical mode when driven by a poled active layer 104 of P(VDF-TrFE) having a thickness of 20 microns. As shown in FIG. 2, the critical thickness of the substrate 101 decreases as the elastic modulus of the substrate 101 increases (i.e., substrates made of materials having higher elastic moduli may be thinner before reaching the buckling limit than substrates made of materials having lower elastic moduli). For instance, the minimum thickness before buckling of a substrate 101 having an elastic modulus of 50 GPa is approximately 200 microns, whereas the minimum thickness of a substrate 101 having an elastic modulus of 200 GPa is approximately 125 microns. In one embodiment, the residual poling strain may be countered by providing an additional thin, stressed coating layer on the substrate 101. In an alternate embodiment, the deformable mirror 100 may be provided without the substrate 101, and the reflective layer 109 may be coupled directly to the first active layer 104.

Generally, silicon and glass substrates 101 are manufactured nominally flat. Accordingly, in one embodiment, the deformable mirror 100 includes a stressed oxide coating applied to the substrate 101 to introduce a baseline curvature to the substrate 101. Providing a stressed coating on the substrate 101 decreases the demand on the active layers 104, 105 and the electrode layers 106, 107 to deform the deformable mirror 100. In one embodiment, the stressed coating is silicon dioxide grown in a furnace with either O2 or H2O vapor at very high temperatures, such as approximately 1000° C. The stressed coating can have any suitable thickness, such as, for example, approximately 100 nm to approximately 10 microns. The stressed coating may impart any suitable stress on the substrate 100, such as, for example, approximately 100 MPa to approximately 1000 MPa.

Additionally, to curve the substrate 101 beyond the limit at which the substrate 101 would otherwise buckle into a cylindrical shape, a stiffening rim 110 can be coupled to a peripheral edge 111 of the outer surface 103 of the substrate 101, as illustrated in FIGS. 1A and 1B. The stiffening rim 110 is configured to maintain the substrate 101 in an axisymmetric curved shape beyond the buckle limit of the substrate 101 (i.e., the stiffening rim 110 is configured to support the edge 111 of the substrate 101 and thereby prevent the substrate 101 from buckling). In the illustrated embodiment, the stiffening rim 110 includes a ring 124 and a plurality of outwardly projecting tabs 125 circumferentially disposed in regular intervals around the ring 124. The ring 124 surrounds the substrate 101 and is coupled to the edge 111 of the substrate 101 to resist buckling. The tabs 125 on the stiffening rim 110 are configured to provide an electrical interface for the electrodes 112, 113 on the electrode layers 106, 107. In the illustrated embodiment, each of the electrodes 112, 113 include a lead or a trace 126 configured to be coupled to control electronics 115, described in detail below. The traces 126 overlie and are supported by the tabs 125 on the stiffening rim 110. In one embodiment, the deformable mirror 100 includes a nominally flat 100 microns thick silicon substrate 101, a stressed oxide coating provided on the substrate 101 to impart a 2.5m radius of curvature to the substrate 101, and a 10 mm wide and 0.5 mm thick silicon rim 110 coupled to the periphery 111 of the substrate 101 in order to maintain the 2.5m radius of curvature. In one embodiment, a series of actuators may be provided on the stiffening rim 110 such that the periphery 111 of the deformable mirror 100 can be deformed (e.g., the actuators on the stiffening rim 110 may be configured such that the periphery 111 of the mirror 100 can expand and contract and deform out of plane). In one embodiment, electrodes may be provided on both a top and bottom surface of the stiffening rim 110 such that the stiffening rim 110 is configured to bend inward and outward as well as radially expand and contract.

With continued reference to FIG. 1A, the active layers 104, 105 are coated on the first surface (or inner surface) 102 of the substrate 101. For example, in some embodiments, the active layers 104, 105 are substantially uniformly coated over substantially the entire inner surface 102 of the substrate 101. As used herein, the terms “substantially” and “uniformly” are used as terms of approximation and not as terms of degree, and are intended to account for the inherent deviations in measured or calculated values that would be recognized by those of ordinary skill in the art. Accordingly, as used herein, the term “substantially uniformly coated” and similar terms are used as terms of approximation to denote that the thicknesses of the active layers 104, 105 are constant across the substrate 101 and any deviations are negligible. Similarly, as used herein, “substantially the entire inner surface” and similar terms mean that any areas or portions of the inner surface 102 not covered by the active layers 104, 105 are negligible. Substantially uniformly coating the active layers 104, 105 over the entire inner surface 102 of the substrate 101 is configured to minimize print-through effects of the electrode pattern onto the reflective surface of the mirror 100. The active layers 104, 105 may be formed of any suitable material, such as piezoelectric polymers (e.g., polyvinylidene fluoride (PVDF) or one of its copolymers, such as poly(vinylidene fluoride trifluoroethylene) P(VDF-TrFE), P(VDF-HFP), or P(VDF-TrFE-HFP)), piezoelectric ceramics (e.g., lead zirconate titanate (PZT) or BaTO₃), electrostrictive materials (e.g., PMN, PMN-PT, or PLZT), dielectric elastomers, or magnetostrictives (e.g., Terfenol-D). For example, in some embodiments, the active layers 104 and 105 are made of piezoelectric polymers, e.g., PVDF and its copolymers, such as poly(vinylidene fluoride trifluoroethylene) P(VDF-TrFE), P(VDF-HFP), or P(VDF-TrFE-HFP. As described in further detail below, the active layers 104, 105 may be poled to change them from paraelectric to piezoelectric in order to align the electric dipole domains within the materials and configure the active layers 104, 105 to be actuated with lower voltages (e.g., 25 MV/m) (e.g., P(VDF-TrFE) is a semi-crystalline, electro-active, thermoplastic fluoropolymer that can be made piezoelectric by poling at room temperature). The active layers 104, 105 may have any suitable thicknesses, such as approximately 1 micron to about approximately 100 microns. In one embodiment, for example, the active layers 104, 105 each have a thickness of approximately 20 microns. Additionally, two parameters that may be used for the selection of the active layers 104, 105 are the maximum actuation strain (i.e., the strain achieved by raising the control field to its highest safe value) and the blocked stress (i.e., the stress required to hold the material at zero strain overall while raising the control field to its highest safe value). In one embodiment, piezoelectric polymers may have a maximum actuation strain of approximately 0.1% and a blocked stress of approximately 5 MPa, electrostrictives may have a maximum actuation strain of approximately 0.1% and a blocked stress of approximately 100 MPa, magnetostrictives may have a maximum actuation strain of approximately 0.2% and a blocked stress of approximately 70 MPa, and piezoelectric ceramics may have a maximum actuation strain of approximately 0.2% and a blocked stress of approximately 100 MPa.

The first and second electrode layers 106, 107 each include a plurality of electrodes 112, 113, respectively, configured to be individually actuated or driven in order to achieve a large range of mirror deformation modes (i.e., the electrodes 112, 113 on each of the electrode layers 106, 107 are individually addressable). The electrode layers 106, 107 may have any suitable thickness, such as, for example, approximately 20 nanometers to approximately 3 microns. The electrode layers 106, 107 may be formed from any suitable conductive material, such as copper, gold, silver, titanium, aluminum, conductive polymers, or transparent conductors. Gold electrode layers 106, 107 are configured to prevent oxidation, but an intermediate layer of titanium or chromium may be required to promoted adhesion between the gold electrode layers 106, 107 and the active layers 104, 105. Additionally, in some embodiments, the first and second electrode layers 106, 107 have a substantially uniform thickness across the first and second active layers 104, 105, respectively. As described above, the terms “substantially” and “uniform” are used as terms of approximation and not as terms of degree, and are intended to account for the inherent deviations in measured or calculated values that would be recognized by those of ordinary skill in the art. Accordingly, as used herein, the term “substantially uniform thickness” and similar terms are used as terms of approximation to denote that the thicknesses of the electrode layers 106, 107 are constant across the active layers 104, 105 and any deviations are negligible.

Additionally, the electrodes 112, 113 on the electrode layers 106, 107 can be arranged in various patterns. The appropriate pattern may be selected depending upon the desired shape-correcting capabilities of the deformable mirror 100, as described in more detail below. In the illustrated embodiment of FIG. 1A, the first electrode layer 106 has an electrode pattern which is different from the electrode pattern of the second electrode layer 107. However, the present invention is not limited to this configuration, and the first and second electrode layers 106 and 107 can have the same or similar patterns, or the mirror 100 may include only one electrode layer 106. In some embodiments, as shown in FIG. 1A, the first electrode layer 106 includes relatively larger (i.e., larger relative to the electrodes 113 of the second electrode layer 107) arcuate or semi-annular electrodes 112 disposed in a pattern of concentric rings, and the second electrode layer 107 includes relatively smaller (i.e., smaller relative to the electrodes 112 of the first layer 106) rectangular electrodes 113 arranged in a triangular lattice pattern. The relatively larger electrodes 112 in the first electrode layer 106 are configured to provide coarse, low order deformations (i.e., corrections) to the mirror, whereas the relatively smaller electrodes 113 of the second electrode layer 107 are configured to provide fine, localized deformations. Additionally, the larger electrodes 112 have a relatively larger stroke capability than the smaller electrodes 113. The stroke capability of an electrode is defined as the resultant deformation of the mirror when the maximum (i.e., saturation) voltage is applied to the electrode. Accordingly, the larger, coarse pattern electrodes 112 are configured to change the focal length of the mirror 100 without relying upon the available stroke of the fine pattern electrodes 113, and the fine pattern electrodes 113 may be reserved for fine-tuning the shape of the mirror 100 once the mirror 100 approaches the optimum curvature. Accordingly, complementary actuation modes can be created by stacking multiple active layer 104, 105 and multiple electrode layers 106, 107, each with its own set of unique electrode patterns.

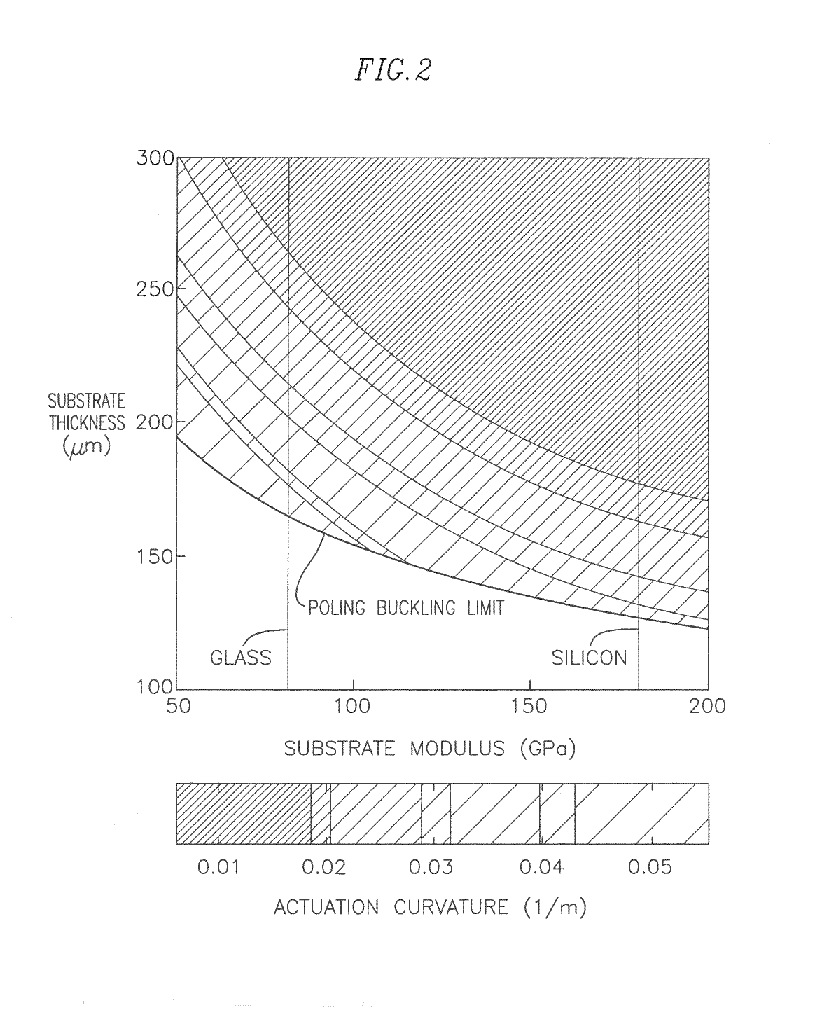

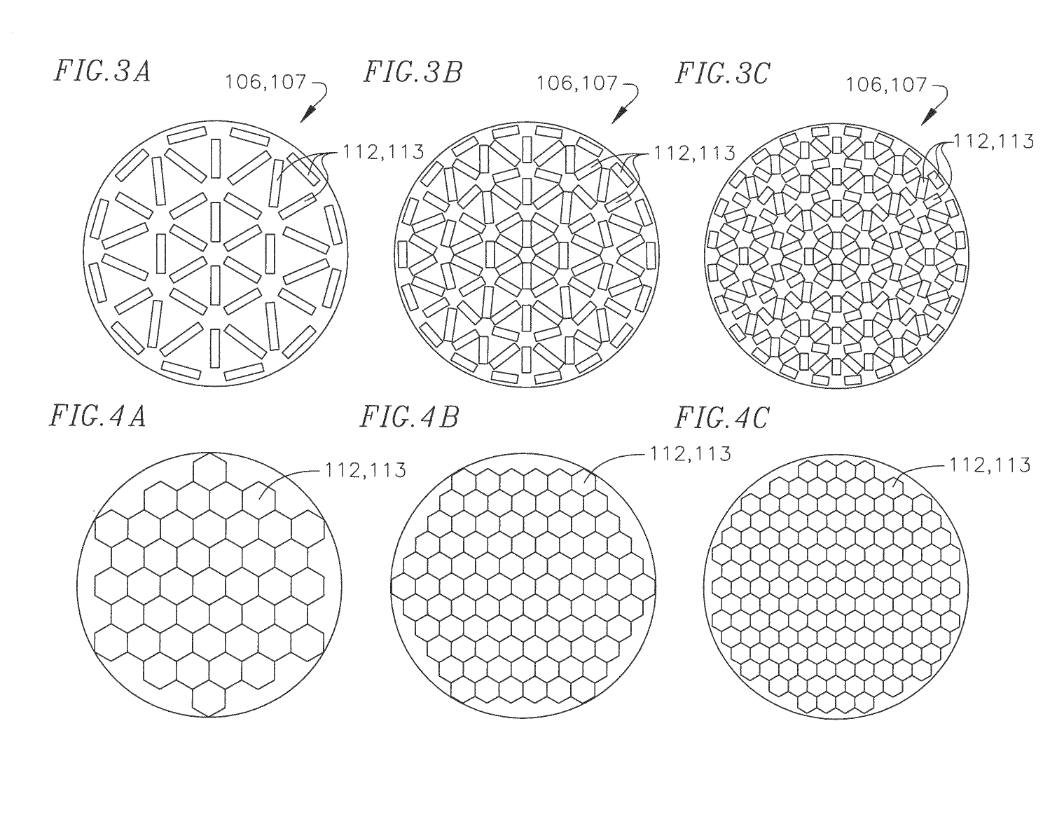

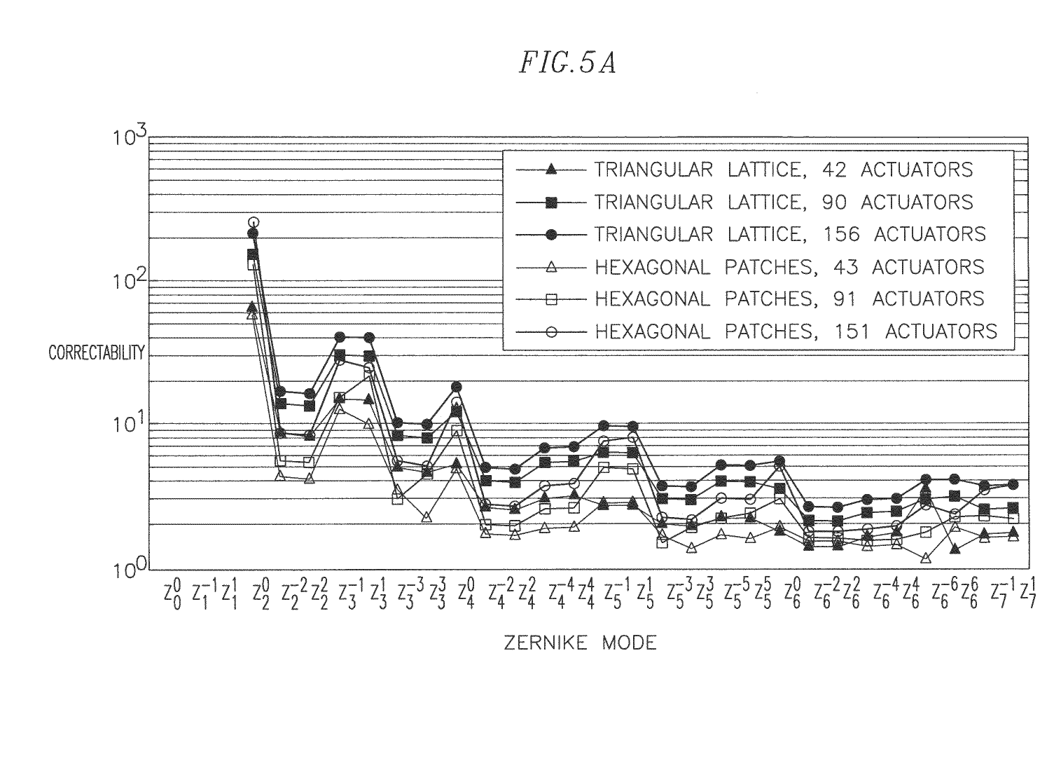

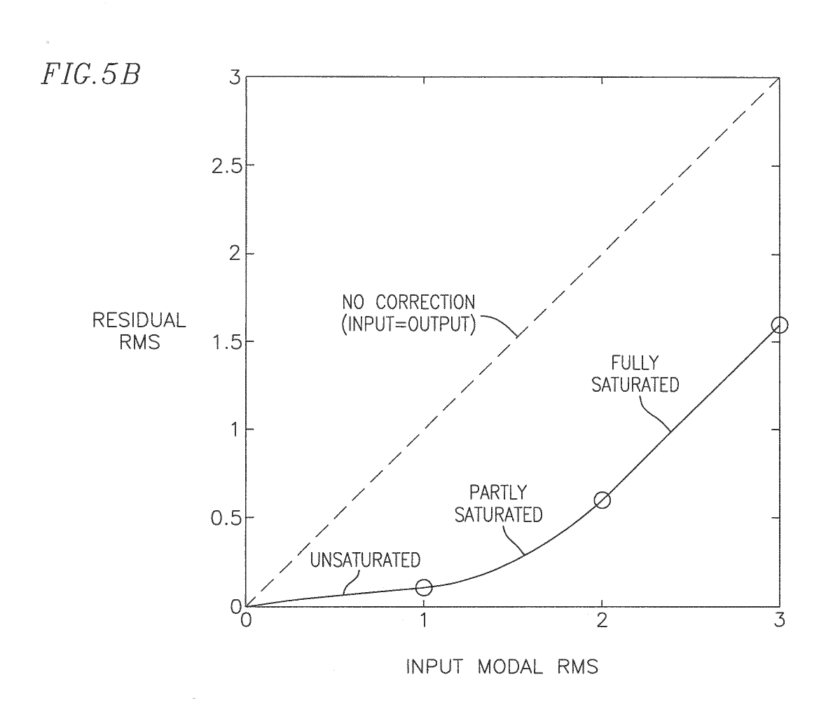

With reference now to FIGS. 3A-4C, electrode layers 106, 107 having various patterns and densities of electrodes 112, 113 are illustrated. The electrode layers 106, 107 illustrated in FIGS. 3A-3C include a plurality of electrodes 112, 113 arranged in a variety of patterns. For example, in some embodiments, as illustrated in FIGS. 3A-3C, the electrodes 112, 113 are rectangular in shape and are arranged in groups of three electrodes 112, 113. Each group of three rectangular electrodes 112, 113 defines a generally triangular shape. Together, the triangular groups of electrodes define a triangular lattice pattern of electrodes. These triangular lattice patterns have varying electrode densities depending on the sizes of the electrodes and the triangular groups. The electrode layer 106, 107 illustrated in FIG. 3C has the highest electrode density (e.g., 156 electrodes), the electrode layer 106, 107 in FIG. 3B has fewer electrodes (e.g., 90 electrodes), and the electrode layer 106, 107 in FIG. 3A has the lowest electrode density (e.g., 42 electrodes). The electrodes 112, 113 illustrated in FIGS. 4A-4C are hexagonal in shape and are arranged in a tessellation (i.e., edges of the hexagonal electrodes 112, 113 abut edges of adjacent electrodes 112, 113 such that no gaps or overlaps are defined between adjacent hexagonal electrodes 112, 113). These tessellations of hexagonal electrodes have varying densities depending upon the size of the hexagonal electrodes 112, 113. The electrode layer 106, 107 illustrated in FIG. 4C has the highest electrode density (e.g., 151 electrodes), the electrode layer 106, 107 in FIG. 4B has fewer electrodes (e.g., 91 electrodes), and the electrode layer 106, 107 in FIG. 4A has the lowest electrode density (e.g., 43 electrodes). It will be appreciated, however, that the electrodes 112, 113 may be arranged in any other suitable pattern and with any other suitable electrode density based upon the desired stroke and deformation modes of the mirror. In addition, according to some embodiments, one of the first or second electrode layers 106, 107 may not be patterned. An unpatterned electrode layer may be used as a grounding layer or a voltage reference for the other layers. Additionally, an unpatterned electrode layer may be used for bulk curvature changes in the shape of the mirror.

The root-mean-square (RMS) surface error (i.e., deviation from nominal shape) is a simple scalar measure of the shape-related performance of a mirror. Although high spatial frequency components of the RMS error will be governed by the mirror surface roughness, which is related to manufacturing techniques and processes that cannot be addressed with shape correction, minimization of the low- to mid-frequency components of the RMS error may be achieved through the use of a sufficient number of actuators (i.e., electrodes) that bend/stretch the mirror 100 into the desired shape. The influence functions of a series of electrode actuators provided on a mirror surface will now be described.

Consider m sampling points (nodes) distributed on the surface of a general mirror surface with an associated control system with n actuators (i.e., electrodes). Associated with the i^{th} actuator is a column vector, aᵢ ε [symbol] ^{m},i=l ...n, obtained from the nodal deflections of the mirror due to a unit input (e.g. 1 volt) to the i^{th} actuator, while all other actuators are turned off. This column vector is known as the “influence vector” of actuator i, since it determines the influence that the actuator has on the mirror surface. The influence vector of actuator i is linearly independent from the other n−1 vectors, corresponding to the other actuators. The influence vectors are assembled into the influence matrix, A, as follows: A=[a₁a₂ . . . aₙ]ε [symbol] ^{m×n}. It is assumed that all deviations from the initial surface shape are small with respect to the diameter of the mirror. This assumption allows linear combinations of the influence vectors to be used to predict the mirror deflections. Hence, the influence matrix can be used to transform a “control vector,” uε [symbol] ⁿ, containing the actuator input values, into a “shape deflection vector,” δε [symbol] ^{m}, which contains the deflection of all nodal points of the mirror. Thus, the control vector and shape deflection vector are related via the influence matrix by: Au=δ.

The correction of the mirror from its current shape, s₁ ε [symbol] ^{m}, to a desired shape, s₂ ε [symbol] ^{m} requires a deflection δ=s₂−s₁. Even assuming that the appropriate vector norm (e.g., 2-norm or RMS) of δ is small, this deflection vector will, in general, not belong to the rangespace of A. Therefore, the appropriate control vector is obtained from the least squares (LS) solution of Au=δ.

For generality, the nodal deflections are weighted by appropriate surface areas, Sᵢ, to make the shape control formulation independent of meshing or sampling non-uniformities. The values to Si may be found by calculating the Voronoi area surrounding each node. These area weights are arranged along the diagonal of a matrix, W ε [symbol] ^{m×m}, and Au=δ is then modified to: WAu=Wδ. The weighted, least squares solution of WAu=Wδ can be calculated using the QR factorization or other methods, and software packages such as MATLAB have in-built functionality to compute these solutions efficiently. If the available actuator inputs are constrained to a certain range, then a constrained, weighted, linear least squares solution would be required to find the optimal u. Once the solution u has been determined, the difference between the approximation and the original is the residual vector or “residual shape error,” r=Au−δε [symbol] ^{m} or, accounting for the weights in the residual, \hat{r}WAu−WδεR^{m}. For convenience, the weights in W can be re-defined as the square roots of Sᵢ non-dimensionalized by the total mirror surface area. Thus, the 2-norm of \hat{r} is then equivalent to the RMS surface error:

$${‖ \hat{r} ‖}_{2} = \sqrt{{\hat{r}}^{T} \hat{r}} = \sqrt{{( Au - δ )}^{T} {W}^{2} ( Au - δ )} ≡ \sqrt{\frac{{\sum }_{i} {r}_{i}^{2} {S}_{i}}{{\sum }_{i} {S}_{i}}} .$$

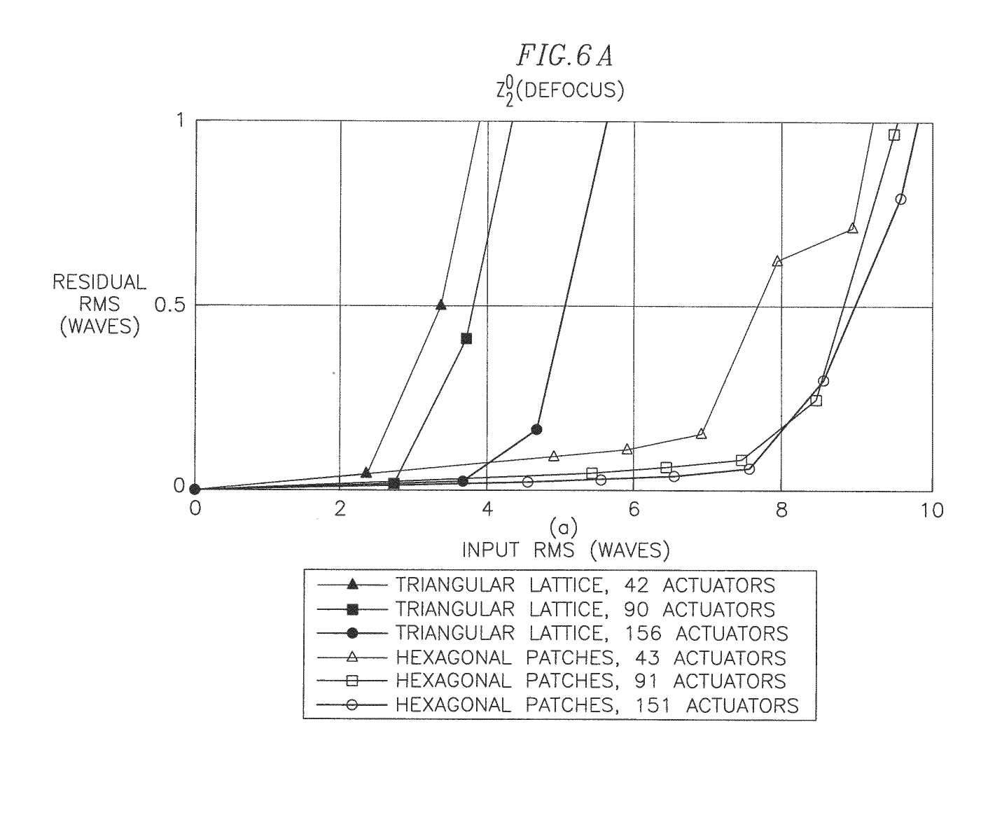

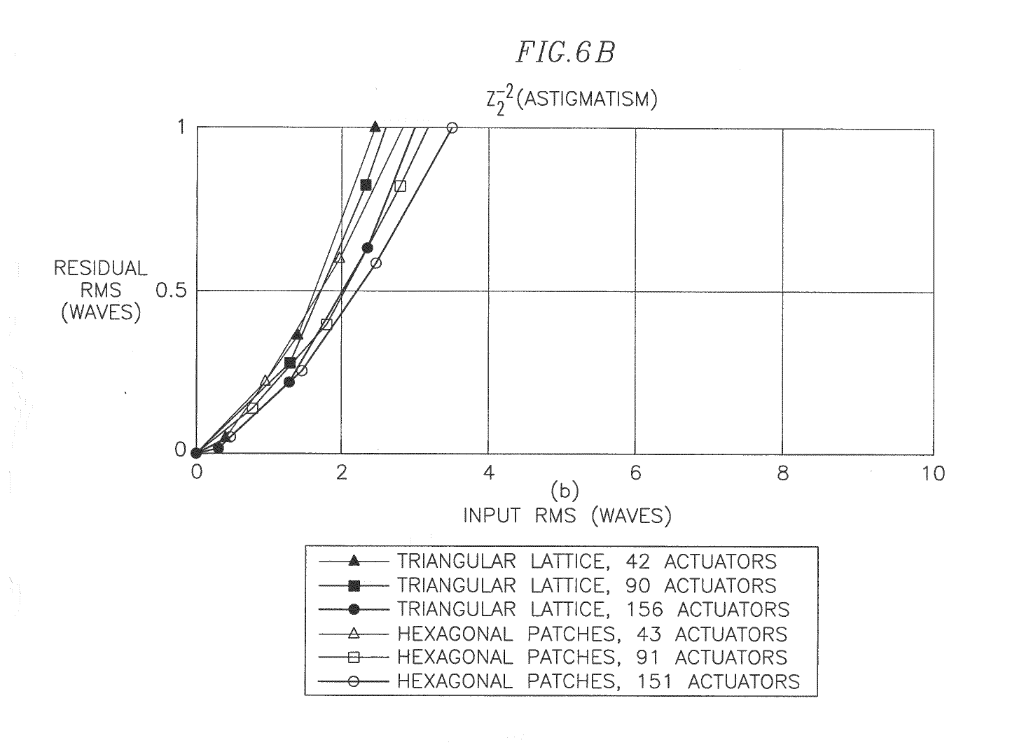

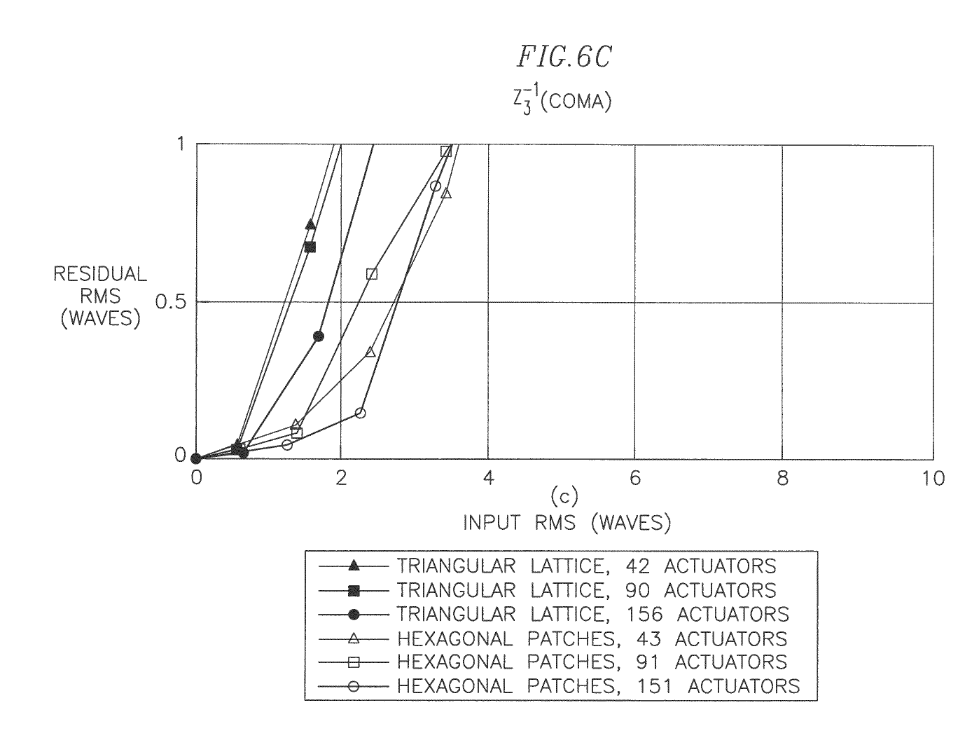

The ability of each of the electrode layers 106, 107 illustrated in FIGS. 3A-4C to correct for an error in the shape of the mirror (i.e., an optical aberration) is illustrated in FIGS. 5A and 6A-6C. FIG. 5A illustrates the ability of each of the electrode patterns to correct for thirty different errors in the shape of the mirror, and FIGS. 6A-6C illustrate the ability of each of the electrode patterns to correct for three different low-order errors (defocus, astigmatism, and coma) in the shape of the mirror. The correctability of each electrode layer 106, 107 is defined as the ratio of input root mean square (RMS) error to the output (corrected) residual RMS error. FIG. 5A illustrates the ability of each of the electrode layers 106, 107 illustrated in FIGS. 3A-4C to correct for optical aberrations represented by the first thirty Zernike aberration modes. Zernike modes are a set of orthogonal polynomials defined over a unit disk used to represent various optical aberrations (e.g., tilt, defocus, astigmatism, trefoil, coma, and spherical aberration). In FIG. 5A, the Zernike modes are expressed in radial form, Z_{b}^{a}, where a is the azimuthal order and b is the radial order. FIGS. 6A-6C illustrate the correctability of each of the electrode layers 106, 107 illustrated in FIGS. 3A-4C when subject to a defocus aberration in the mirror (FIG. 6A), an astigmatism aberration in the mirror (6B), and a coma aberration in the mirror (FIG. 6C).

As illustrated in FIGS. 5A-5B and 6A-6C, as the amplitude of the input error increases (i.e., as the order of the Zernike mode increases), the correctability of the electrode layers 106, 107 decreases because an increasing number of electrodes 112, 113 reach saturation (e.g., 500V). As shown in FIG. 5B, the general relationship between the amplitude of the input RMS error in the chosen Zernike mode and the output (corrected) residual RMS error is non-linear as an increasing number of electrodes reach saturation, and becomes a line of slope equal to one when all electrodes are saturated. However, increasing the electrode density in the electrode layers 106, 107 improves both the shape correction accuracy and the available stroke of the mirror. For instance, as illustrated in FIG. 5A, a mirror aberration corresponding to the fourth Zernike mode (defocus) can be corrected by a factor of over 200 times the original error magnitude by the electrode layer 106, 107 having the densest triangular lattice of electrodes (FIG. 3C), whereas the electrode layer 106, 107 having the least dense triangular lattice of electrodes (FIG. 3A) can correct the fourth Zernike mode by a factor of approximately 60 times the original error magnitude.

Additionally, as illustrated in FIGS. 5 and 6A-6C, the electrode layers 106, 107 having the triangular lattice pattern of electrodes (see FIGS. 3A-3C) generally exhibit a higher degree of correctability than the electrode layer 106, 107 having the tessellation of hexagonal electrodes (see FIGS. 4A-4C). The electrode layers 106, 107 having the triangular lattice pattern of electrodes 112, 113 exhibit a higher degree of correctability because the electrodes 112, 113 are provided in multiple orientations, which configure the electrode layer 106, 107 to have better control over deforming the substrate 101 in arbitrary directions (i.e., orienting the electrodes 112, 113 in various directions aids in correcting aberrations that require a non-axisymmetric deformation of the shape of the mirror). For instance, as illustrated in FIG. 5A, the electrode layer 106, 107 having the densest triangular lattice of electrodes (FIG. 3C) can correct a mirror aberration corresponding to the fifth Zernike mode (astigmatism) by a factor of approximately 18 times the original error magnitude, whereas the electrode layer 106, 107 having the densest hexagonal electrodes (FIG. 4C) can correct the fifth Zernike mode by a factor of approximately 8 times the original error magnitude. However, the electrode layer 106, 107 having the tessellation of hexagonal electrodes 112, 113 is configured to achieve larger strokes before saturation than the electrode layer 106, 107 having the triangular lattice pattern of electrodes 112, 113 because the hexagonal electrodes cover a greater surface area of the substrate 101, which increases the total potential actuation force of the electrodes 112, 113.

In one embodiment, the deformable mirror 100 is thermally stable (i.e., the composite coefficient of thermal expansion of the deformable mirror 100 is substantially zero). As described above, the term “substantially” is used herein as a term of approximation and not as a term of degree, and is intended to account for the inherent deviations in measured or calculated values that would be recognized by those of ordinary skill in the art. Accordingly, as used herein, the term “substantially zero” and similar terms are used as terms of approximation to denote that any deviation from a composite coefficient of thermal expansion of zero is negligible. Otherwise, coefficient of thermal expansion mismatches between the various layers may cause undesirable bending in the mirror 100.

In general, a laminate made of layers of different materials will bend when the laminate is subjected to bulk temperature changes. For a laminate made of a substrate and a number of layers stacked on the substrate, and assuming that all of the layers are much thinner than the substrate, an overall curvature, κ, of the laminate resulting from a temperature change, ΔT, can be estimated by substituting into Stoney's formula, provided above, the thermal strain (relative to the substrate thermal strain), εᵢ−εₛ=(αᵢ−αₛ)ΔT. Allowing for layers attached to both the top and the bottom of the substrate, the overall curvature, κ, can be obtained by superimposing the individual effects of the layers, as follows:

$$κ = {\sum }_{i} \frac{6 {s}_{i} ( {ɛ}_{i} - {ɛ}_{s} ) {M}_{i} {t}_{i}}{{t}_{s}^{2} {M}_{s}} = {\sum }_{i} \frac{6 {s}_{i} ( {α}_{i} - {α}_{s} ) Δ {TM}_{i} {t}_{i}}{{t}_{s}^{2} {M}_{s}} = \frac{6 Δ T}{{t}_{s}^{2} {M}_{s}} {\sum }_{i} {s}_{i} ( {α}_{i} - {α}_{s} ) {M}_{i} {t}_{i} ,$$

where αₛ and αᵢ are the coefficients of thermal expansion of the substrate and the additional layers, respectively, tₛ and tᵢ are the thicknesses of the substrate and the additional layers, respectively, and Mₛ and Mᵢ are the biaxial moduli of the substrate and the additional layers, respectively, and where sᵢ=+1 for a layer provided on top of the substrate and sᵢ=−1 for a layer provided on the bottom of the substrate.

Thermal bending can be prevented by means of additional layers that balance the laminate thermal stresses. In particular, additional layers with appropriate thickness may be provided either on the ton or the bottom of the substrate until the overall thermal curvature, κ, of the laminate is zero:

$$κ = 0 = {\sum }_{i} {s}_{i} ( {α}_{i} - {α}_{s} ) {M}_{i} {t}_{i} .$$

Accordingly, the deformable mirror 100 can include one or more thermal balancing layers to balance the thermal stresses in the deformable mirror 100 (i.e., a thermal balancing layer can be provided on the outer surface of the substrate 101 to balance the coefficients of thermal expansion of the substrate 101 and the active layers 104, 105). In general, the active layers 104, 105 have a relatively high coefficient of thermal expansion and the substrate 101 has a relatively low coefficient of thermal expansion. Accordingly, a thermal balancing layer having a moderate coefficient of thermal expansion may be provided on the outer surface 103 of the substrate 101 to thermally stabilize the deformable mirror 100. In one embodiment, a silicon substrate 101 has a biaxial modulus of 180 GPa and a coefficient of thermal expansion of 2.6 ppm/K, a P(VDF-TrFE) active layer 104 has a biaxial modulus of 2.3 GPa and a coefficient of thermal expansion of approximately 220 ppm/K, and an aluminum reflective layer 109 or thermal balancing layer has a biaxial modulus of 120 GPa and a coefficient of thermal expansion of 23 ppm/K. As an example of thermal balancing in the deformable mirror 100, in one embodiment, a deformable mirror 100 having a 100 micron thick silicon substrate 101 and a 20 micron thick PVDF active layer 104 can be thermally balanced by providing a 3 micron thick aluminum coating layer on the outer surface 103 of the substrate 101. As another example, in another embodiment, a deformable mirror 100 having a 200 micron thick silicon substrate 101 and a 20 micron thick PVDF active layer 104 can be thermally balanced by providing a 4 micron thick aluminum coating layer on the outer surface 103 of the substrate 101. As can be seen from these examples, the thermal balancing layer is selected in order to balance the coefficient of thermal expansion of the deformable mirror 100. As such, and as would be understood by those of ordinary skill in the art, the thickness and material of the thermal balancing layer will vary depending on the composite coefficient of thermal expansion of the remaining layers of the deformable mirror 100. Accordingly, although the thermal balancing layer is described herein as including aluminum at a thickness of either 3 or 4 microns, it is understood that a different material or layer thickness may be needed in order to achieve proper thermal balancing of the deformable mirror, e.g., when the substrate 101 and active layers 104, 105 are made of different materials or are deposited at different thicknesses.

Additionally, while a separate thermal balancing layer (as described above) may be used to balance the composite coefficient of thermal expansion, in some embodiments, this separate thermal balancing layer is omitted, and the composite coefficient of thermal expansion is balanced by adjusting the material and thickness of the reflective layer 109. For example, the properties of the reflective layer 109 may be selected such that a separate coating layer is not necessary to thermally balance the deformable mirror 100. In one embodiment, for example, the reflective layer 109 may include a bimetallic lattice including two materials having different coefficients of thermal expansion that are selected to tune the coefficient of thermal expansion of the bimetallic lattice to a particular value. Such a reflective layer 109 having a tunable coefficient of thermal expansion enables tuning of the composite coefficient of thermal expansion of the deformable mirror 100. For example, the materials of the bimetallic lattice may be selected to provide a reflective layer 109 that, when used in a deformable mirror 100 according to embodiments of the present invention, provides a composite coefficient of thermal expansion of the deformable mirror 100 of substantially zero. Bimetallic lattices that may be used as the reflective layer in the deformable mirrors according to the present invention are described in a U.S. Patent Application entitled “Thin Film Bi-Material Lattice Structures and Methods of Making the Same,” filed on Apr. 17, 2013, the entire content of which is incorporated herein by reference.

With reference now to FIG. 7, control electronics 115 for driving the individual electrodes 112, 113 on the first and second electrode layers 106, 107 are schematically illustrated. In the illustrated embodiment, the control electronics 115 include a microcontroller 116 connected to an amplifier 117. In one embodiment, the amplifier 117 is configured to amplify the analog output 118 of the microcontroller 116 into a range of approximately −500 V to approximately +500 V. The amplified signal 119 is then multiplexed by a multiplexer 120. The multiplexed signal 121 is then transmitted through a plurality of solid state switches 122 and into the individual electrodes 112, 113 on the electrode layers 106, 107. The microcontroller 116 is configured to cycle through each electrode 112, 113 and set the desired voltage, which is held substantially constant until the next refresh cycle. As described above, the term “substantially” is used herein as a term of approximation and not as a term of degree, and is intended to account for the inherent deviations in measured or calculated values that would be recognized by those of ordinary skill in the art. Accordingly, the term “substantially constant” is used herein to allow for the possibility of small voltage leakages between cycles which may reduce the voltage applied to the electrodes. The control electronics 115 also include a wavefront sensor 123 configured to measure the shape of the mirror 100 and transmit the mirror shape data back to the microcontroller 116. Accordingly, the control electronics 115 are configured to selectively deliver a desired voltage to one or more of the electrodes 112, 113 to deform a particular region or regions of the mirror 100 depending upon the desired correction to the shape of the mirror 100.

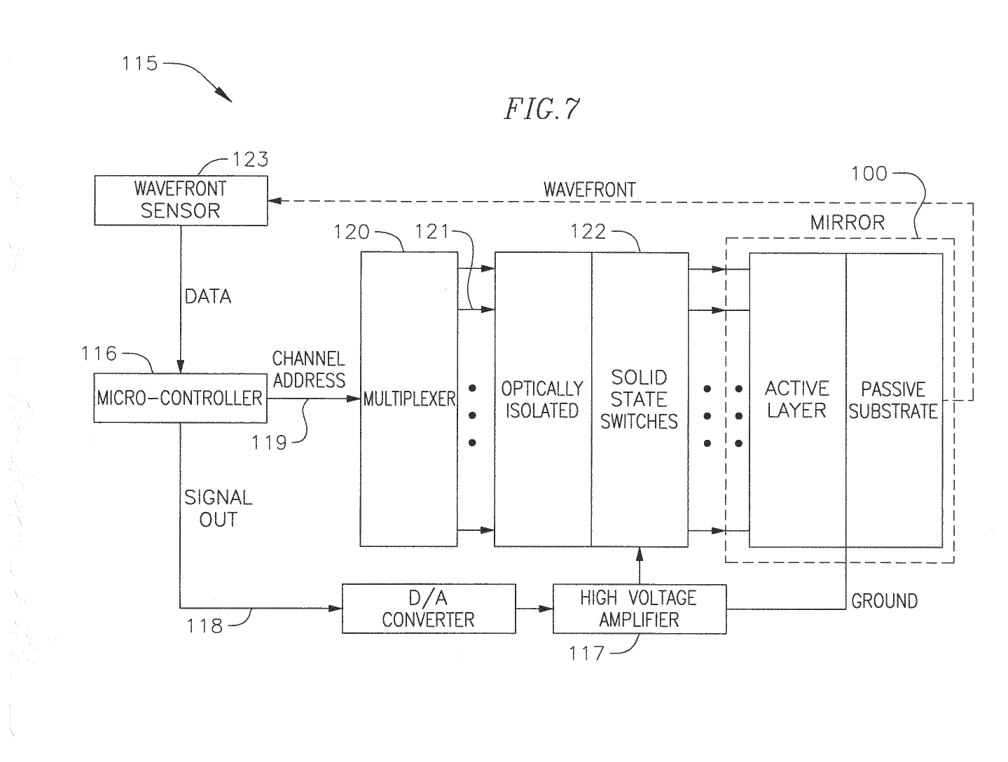

With reference now to FIG. 8, a method 200 of manufacturing a deformable mirror 100 according to embodiments of the present application will be described. In one embodiment, the method 200 includes applying 205 a first active layer 104 on a first surface 102 of a substrate 101. The first active layer 104 is as described above, i.e., it may be formed from any suitable material, such as piezoelectric polymers (e.g., polyvinylidene fluoride (PVDF) or one of its copolymers, such as poly(vinylidene fluoride trifluoroethylene) P(VDF-TrFE), P(VDF-HFP), or P(VDF-TrFE-HFP)), piezoelectric ceramics (e.g., lead zirconate titanate (PZT) or BaTO₃), electrostrictive materials (e.g., PMN, PMN-PT, or PLZT), dielectric elastomers, or magnetostrictives (e.g., Terfenol-D), and may have any suitable thickness, such as approximately 1 micron to about approximately 100 microns. The substrate 101 is as described above, i.e., it may be formed from any suitable material, such as silicon (Si), silicon carbide (SiC), glass (e.g., FS, BK7, borosilicate, lithium aluminosilicate glass-ceramic), carbon fiber composites, or metal (e.g., aluminum, steel, or beryllium), and may have any suitable thickness, such as approximately 50 microns to approximately 1000 microns. Unless a stiffening rim 110 is coupled to the periphery 111 of the substrate 101, the material and thickness of the substrate 101 should be selected to avoid the theoretical lower limit at which point the substrate 101 would buckle into a cylindrical mode.

In one embodiment, applying 205 the first active layer 104 may include spin-coating the material of the first active layer 104 onto the substrate 101. In such an embodiment, the material of the first active layer (e.g., a piezoelectric polymer such as PVDF or P(VDF-TrFE)) is dissolved in an organic solvent to create a relatively high viscosity resin, such as, for example, approximately 100 centipoise (cP). The resin may then be poured onto the inner surface 102 of the substrate 101 as the substrate is rotated on a vacuum chuck. As the substrate is rotated, centrifugal force pushes the resin from the center of the substrate 101 towards the outer edges, resulting in a substantially uniform layer of polymer resin on the substrate 101. As described above, the terms “substantially” and “uniform” are used herein as terms of approximation and not as terms of degree, and are intended to account for the inherent deviations in measured or calculated values that would be recognized by those of ordinary skill in the art. Accordingly, as used herein, the teen “substantially uniform layer” and similar terms are used as terms of approximation to denote that the thickness of the polymer resin is constant across the substrate 101 and any deviations are negligible. The deposited polymer resin layer may then be heat-treated to evaporate the solvent and anneal the thermoplastic polymer. This process of spin-coating a resin onto the substrate 101 and then heat-treating the resin may be repeated until the desired active layer thickness is achieved. Additionally, repeating this process several times is configured to reduce the probability of forming pinhole defects in the active layer 104. In one embodiment, for example, the spin-coating process may be performed three times with a P(VDF-TrFE) resin in order to produce an active layer 104 having a thickness of approximately 20 microns. In another embodiment, applying 205 the first active layer 104 may be performed without heat-treating the resin. In a further embodiment, applying 205 the first active layer 104 may include adhering a sheet of polymer to the inner surface 102 of the substrate 101. Applying 205 the first active layer 104 on the substrate 101 may be accomplished by any suitable deposition or coupling technique, and is not limited to the spin-coating and adhering techniques described here. Indeed, any technique capable of producing a first active layer 104 with a substantially uniform thickness may be used.

The method 200 also includes depositing 210 a first electrode layer 106 onto the first active layer 104. Any suitable deposition technique may be used, for example, physical vapor deposition (e.g., vacuum sputtering or thermal evaporation), electroplating, or the like, of an electrode material (e.g., copper, gold, silver, titanium, aluminum, conductive polymers, or transparent conductors). In one embodiment, depositing 210 the first electrode layer 106 onto the first active layer 104 includes patterning 215 the first electrode layer 106. The first electrode layer 106 may be patterned into any suitable pattern based upon the desired stroke and correctability of the electrode layer 106, such as a plurality of rectangular electrodes 112, 113 arranged in a triangular lattice (see FIGS. 3A-3C), a plurality of tessellated hexagonal electrodes 112, 113 (see FIGS. 4A-4C), or a plurality of semi-annular electrodes 112 arranged in a pattern of concentric rings (see FIG. 1A), described in more detail above. In one embodiment, patterning 215 the first electrode layer 106 includes covering the substrate 101 with a physical shadow mask during the deposition process (e.g., sputtering or thermal evaporation), which blocks deposition of the electrode material in the regions covered by the mask. In other embodiments, patterning 215 the first electrode layer 106 may be accomplished using a resist or photoresist during electron-beam lithographic deposition or photolithographic deposition of the first electrode layer 106. In an alternate embodiment, the first electrode layer 106 may not be patterned.

The method 200 may also include pre-curving 220 the substrate 101. In one embodiment, pre-curving 220 the substrate 101 includes growing a stressed oxide coating on the substrate 101. In embodiments in which the substrate 101 is made of glass, pre-curving 220 the glass substrate 101 may include supporting the glass substrate 101 on a curved mold and raising the temperature of the mold to the transition temperature of the glass substrate material (e.g., approximately 600° C.) such that the glass substrate 101 softens and conforms to the curved shape of the mold. In other embodiments, pre-curving 220 the substrate 101 includes machining a curved surface into the outer surface 103 of the substrate 101, such as, for example, by diamond turning. In further embodiments, pre-curving 220 the substrate 101 may include forming the substrate 101 on a curved mold, such as by sputtering, chemical vapor deposition, spin casting, electroplating, or the like.

With continued reference to the flowchart illustrated in FIG. 8, the method 200 may further include coupling 225 a stiffening rim 110 to the periphery 111 of the substrate 101 to maintain the substrate 101 in an axisymmetric curved shape beyond the buckle limit of the substrate 101, as determined by the buckling formula presented above and illustrated in FIG. 2. The stiffening rim 110 may be coupled to the substrate 101 by any suitable means, such as, for example, bonding or physical vapor deposition (e.g., plasma sputtering or thermal evaporation). The method 200 may also include coupling 230 a grounding layer 108 to the inner surface 102 of the substrate 101 such that the grounding layer 108 is disposed between the substrate 101 and the first active layer 104. The grounding layer 108 may have any suitable thickness, such as, for example, approximately 20 nanometers to approximately 3 microns. The grounding layer 108 may be formed from any suitable conductive material, such as copper, gold, silver, titanium, or aluminum.

The method 200 may also include applying 235 a second active layer 105 onto the first electrode layer 106. The second active layer 105 may be applied using the same deposition or coupling techniques described above with respect to the first active layer 104, e.g., spin-coating or adhesion of a polymer layer.

The method 200 may also include depositing 240 a second electrode layer 107 onto the second active layer 105. The second electrode layer 107 may be deposited using the same deposition techniques described above with respect to the first electrode layer 106, e.g., physical vapor deposition, electroplating, or the like. In one embodiment, depositing 240 the second electrode layer 107 includes patterning 245 the second electrode layer 107 into a desired pattern. The second electrode layer 107 may be patterned using the same techniques as those described above with respect to patterning the first electrode layer 106, e.g., physical shadow masking, photolithography using a photoresist, electron-beam lithography using a resist, or the like.

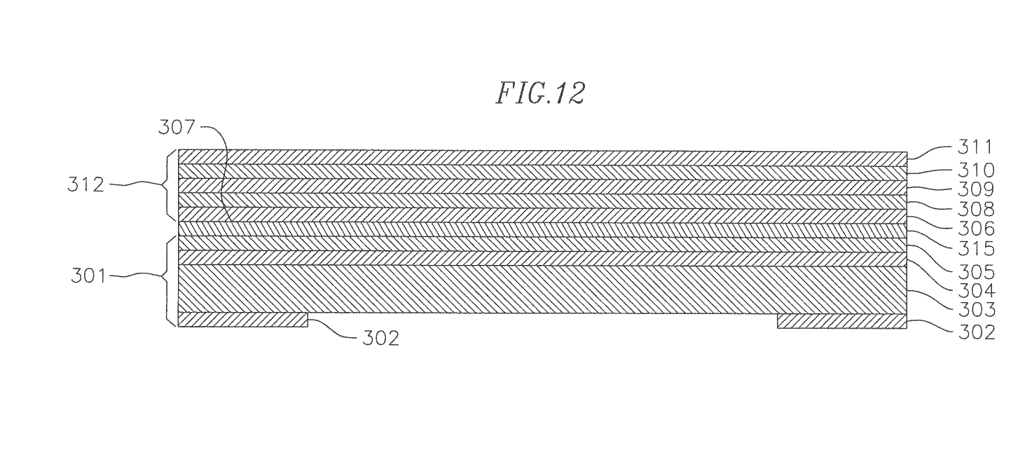

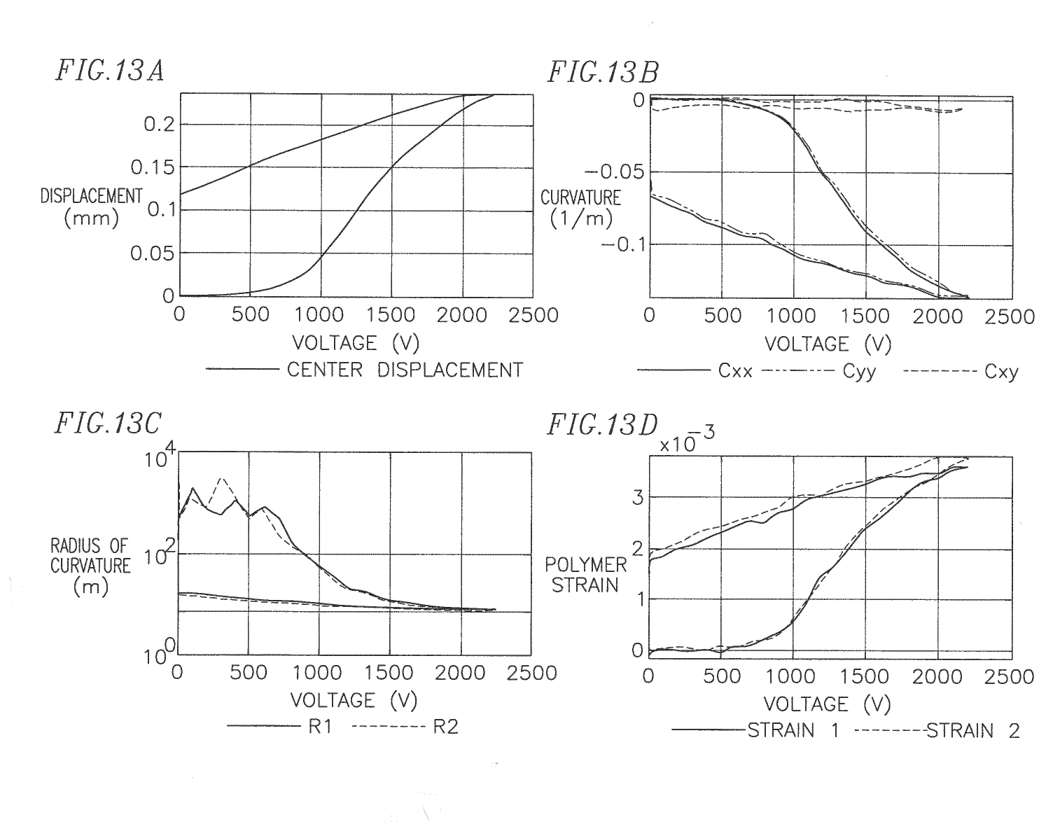

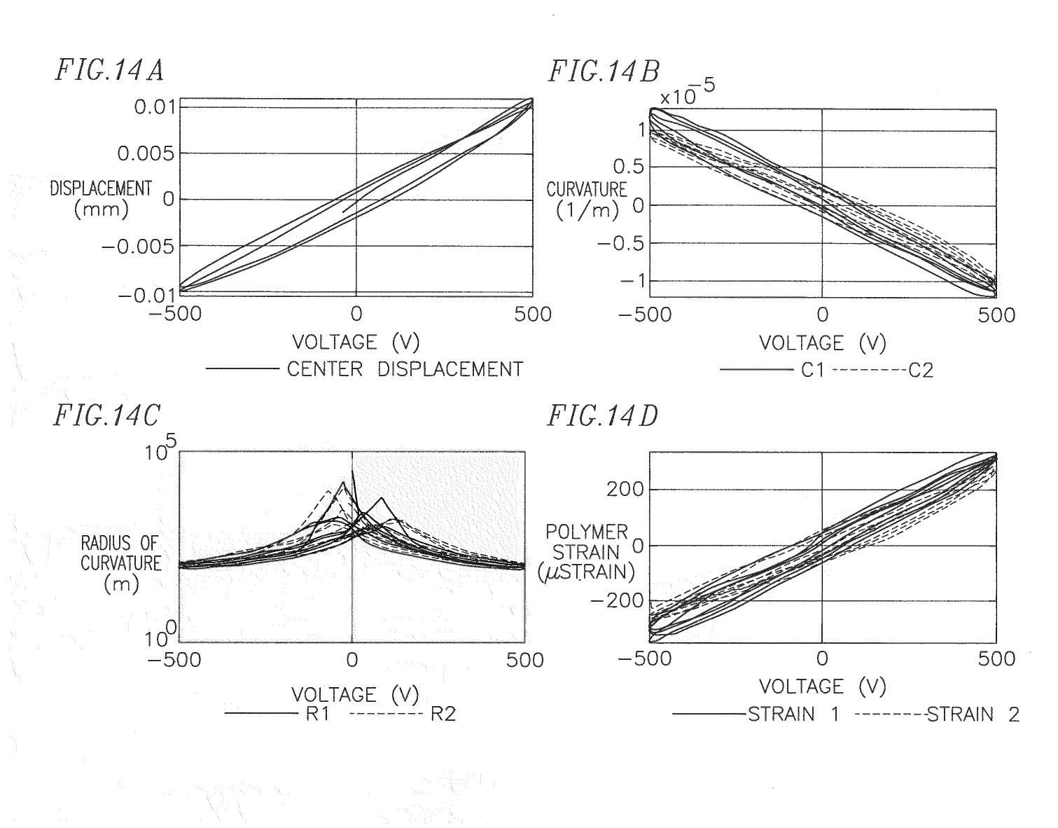

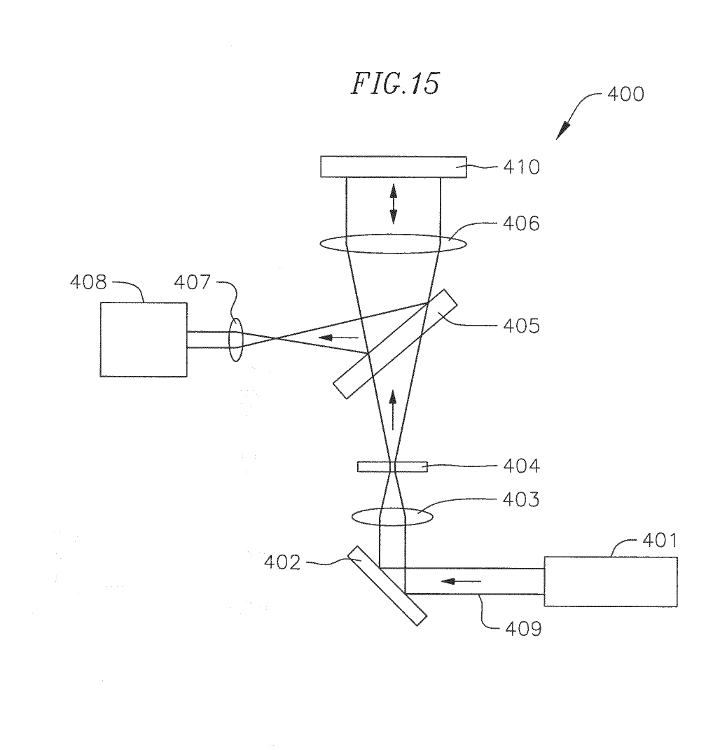

The method 200 may also include poling 250 the first and second active layers 104, 105 in order to impart piezoelectric properties to the active layers 104, 105 (i.e., the state of the active layers 104, 105 is changed from paraelectric to piezoelectric during the poling process). In one embodiment, poling 250 the active layers 104, 105 may include directly applying a relatively large voltage potential, such as approximately 50 MV/m to approximately 100 MV/m, across the active layers 104, 105 in order to align the electric dipoles of the active layers 104, 105 to the applied electric field. After the high poling voltage is removed, the active layers 104, 105 are poled and configured to be actuated by relatively lower voltages (i.e., lower voltages relative to the poling voltage, such as approximately 25 MV/m). In order to prevent print-through effects of the electrode patterns onto the mirror during poling, which would otherwise result from the poling stresses, the voltage potential has to be applied across the entire surface of the active layers 104, 105, not merely the regions of the active layers 104, 105 underlying the patterned electrodes. To facilitate poling the entire active layers 104, 105, a temporary poling electrode may be applied on top of the electrode layers 106, 107. The temporary poling electrode is a thin, uniform coating of metal deposited across the entire surface of the electrode layers 106, 107. After poling the active layers 104, 105, the temporary poling electrode may be removed by any suitable technique, such as plasma etching. In an alternate embodiment, poling 250 the active layers 104, 105 may include corona poling methods. FIGS. 13A-13D illustrate measurements taken during a poling process of a mirror 100 having a single 20 microns thick P(VDF-TrFE) copolymer active layer 104 stacked on a 200 microns thick, 100 mm diameter wafer substrate 101, and an electrode layer 106 deposited on the active layer 104. The electrode layer 106 covered only the central 80 mm diameter of the mirror to prevent electrical arcing around the edge of the mirror. FIG. 13A illustrates the center displacement of the mirror during the poling process, FIG. 13B illustrates the curvature of the mirror during poling, FIG. 13C illustrates the radius of curvature imparted to the mirror during poling, and FIG. 13D illustrates the strain on the active layer during poling. FIG. 13D also illustrates the residual poling strain, εₚ, that remained on the active layer after poling. As illustrated in FIG. 13D, the residual strain, εₚ, was approximately 1.7×10⁻³. FIGS. 14A-14D illustrate the center displacement, curvature, radius of curvature, and strain, respectively, of the same mirror after it had been poled and subject to cycles of −500 V to +500 V.

The method 200 may also include depositing or forming 255 the reflective layer 109 onto the outer surface 103 of the substrate 101, such as by vacuum coating. In another embodiment, forming 255 the reflective layer 109 includes polishing the outer surface 103 of a silicon substrate 101 to create a reflective surface. In a further embodiment, depositing 255 the reflective layer 109 includes attaching or depositing a bimetallic lattice to the outer surface 103 of the substrate 101. Any suitable techniques may be used to polish the outer surface 103 of the silicon substrate 101, such as, for example, grinding, lapping, or other polishing techniques.

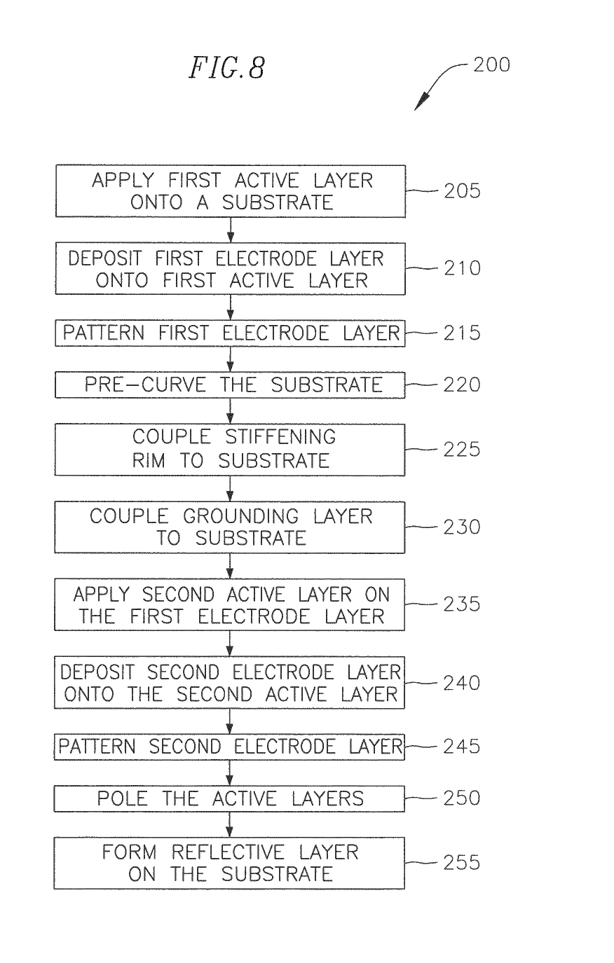

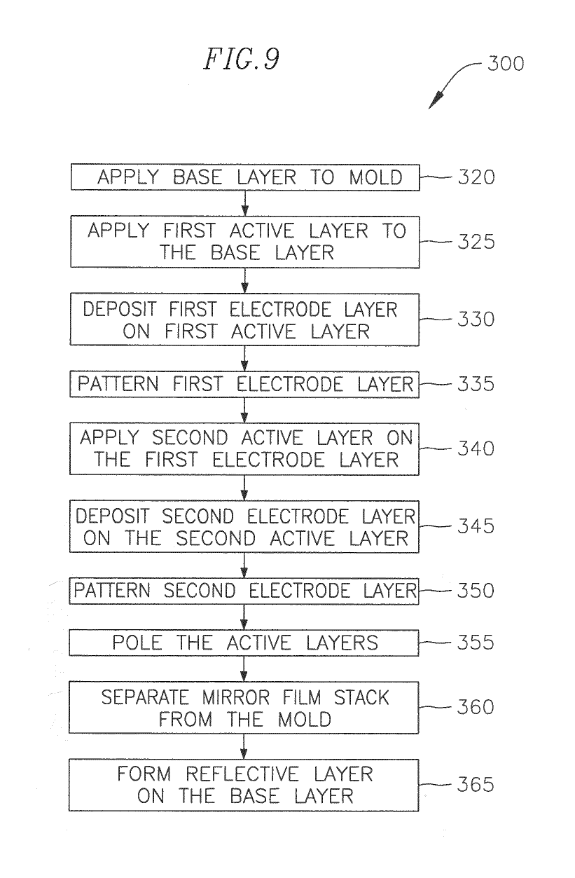

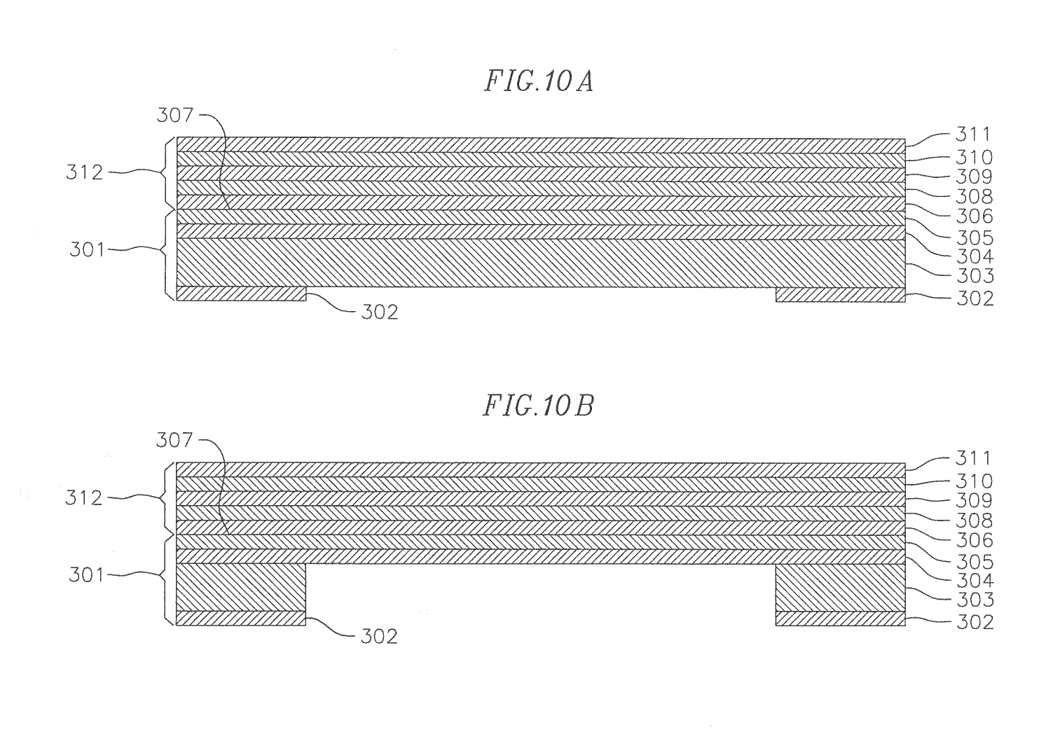

With reference now to FIGS. 9 and 10A-10D, a method 300 of manufacturing a deformable mirror 100 according to another embodiment of the present application will be described. In one embodiment, the method 300 includes applying 320 a base layer 306 to an inner surface 307 of a polished mold 301, such as a silicon wafer or a silicon-on-insulator (SOI) wafer. In the illustrated embodiment of FIG. 10A, the SOI wafer mold 301 includes a first silicon dioxide layer 302, a first silicon layer 303 stacked on the first silicon dioxide layer 302, a second silicon dioxide layer 304 stacked on the first silicon layer 303, and a second silicon layer 305 stacked on the second silicon dioxide layer 304. However, the polished mold 301 is not limited to this configuration. In one embodiment, applying 320 the base layer 306 may include spin-coating a polyimide layer onto the polished mold 301. The base layer 306 may be applied by any other suitable techniques, such as, for example, physical vapor deposition (e.g., plasma sputtering or thermal evaporation). The base layer 306 may have any suitable thickness, such as, for example, approximately 1 micron to approximately 3 microns. Additionally, the base layer 306 may be formed from any suitable material, such as metal (e.g., aluminum).

With continued reference to FIGS. 9 and 10A-10D, the method 300 also includes applying 325 a first active layer 308 on the base layer 306, such as by spin-coating, or any other suitable deposition technique. The first active layer 308 may be applied on the base layer 306 by the same deposition or coupling techniques described above with respect to the first and second active layers 104, 105. The method 300 also includes depositing 330 a first electrode layer 309 onto the first active layer 308, such as by physical vapor deposition (e.g., plasma sputtering or thermal evaporation). The first electrode layer 309 may be deposited on the first active layer 308 by the same deposition techniques described above with respect to the first and second electrode layers 106, 107. In one embodiment, depositing 330 the first electrode layer 309 may include patterning 335 the first electrode layer 309, such as by physical shadow masking, photolithography (i.e., optical lithography), or electron-beam lithography. The first electrode layer 309 may be patterned 335 by the same techniques described above with respect to the patterning of the first electrode layer 106. The method 300 may also include applying 340 a second active layer 310 onto the first electrode layer 309, such as by spin-coating, and depositing 345 a second electrode layer 311 on the second active layer 310, such as by physical vapor deposition (e.g., plasma sputtering or thermal evaporation). The second active layer 310 and second electrode layer 311 may be deposited by the same deposition techniques described above with respect to deposition of the second active layer 105 and second electrode layer 107, respectively. Depositing 345 the second electrode layer 311 may include patterning 350 the second electrode layer 311, such as by physical shadow masking, photolithography (i.e., optical lithography), or electron-beam lithography. The second electrode layer 311 may be patterned using the same techniques described above with respect to the second electrode layer 107. Together, the first and second active layers 308, 310 and the first and second electrode layers 309, 311 define a mirror film stack 312, as illustrated in FIGS. 10A-10D.

With continued reference to FIGS. 9 and 10A-10D, the method 300 may also include poling 355 the first and second active layers 308, 310, such as by a corona poling technique or by directly applying a relatively large voltage potential, such as approximately 50 MV/m to approximately 100 MV/m, across the active layers 308, 310. Poling 355 of the first and second active layers 308, 310 may be accomplished by the same techniques described above with respect to poling 255 of the first and second active layers 104, 105.

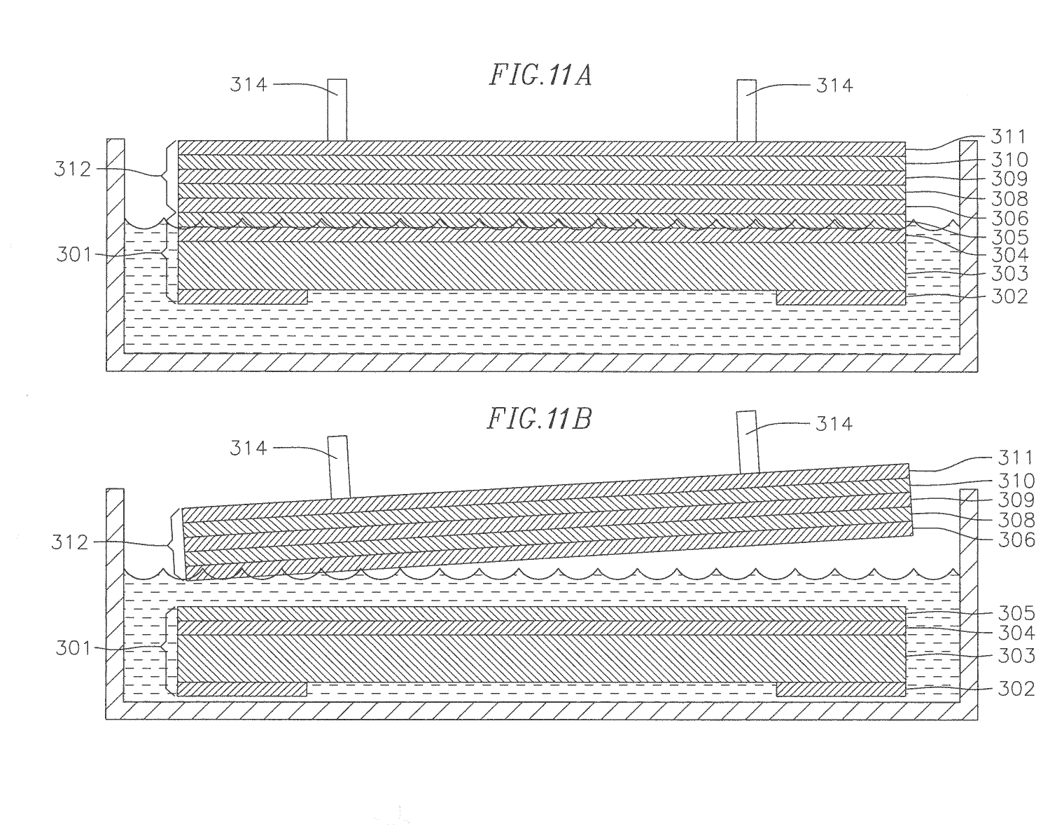

The method 300 may also include separating 360 the mirror film stack 312 from the polished mold 301 (e.g., the SOI wafer). In one embodiment, the adhesion between the base layer 306 and the mold 301 is sufficiently weak such that the mirror film stack 312 may be simply peeled away from the mold 301. In an alternate embodiment, a release layer or sacrificial layer 315 may be provided between the mold 301 and the base layer 306, as illustrated in FIG. 12. The sacrificial layer 315 is configured to dissolve when submerged in a solvent, thereby separating the mirror film stack 312 from the mold 301. The sacrificial layer 315 may be formed from any suitable material, such as, for example, gold or a photoresist polymer. The sacrificial layer 315 may have any suitable thickness, such as, for example, approximately 100 nm to approximately 1 micron. The sacrificial layer 315 may be formed by any suitable process, such as, for example, physical vapor deposition (e.g., sputtering or thermal evaporation), electroplating, or spin-coating.

In another embodiment, separating 360 the mirror film stack 312 from the mold 301 may include etching away at least a portion of the mold 301. In one embodiment, for example, the first silicon layer 303 of the SOI wafer mold 301 may be etched by deep reactive-ion etching (DRIE) (see FIG. 10B), the second silicon dioxide layer 304 may be selectively etched by either hydrofluoric acid-based wet etching or dry plasma etching (see FIG. 10C), and the second silicon layer 305 may be selectively etched by xenon difluoride dry etching (see FIG. 10D). However, the etching process is not limited to this process, and those of ordinary skill in the art would be capable of selecting an appropriate etching profile based on the material of the mold 301. Etching the mold 301 is configured to expose at least a portion of the base layer 306. In some embodiments, the entire mold 301 is removed, exposing the base layer 306. However, in other embodiments, only a portion of the mold 301 is removed. For example, in the embodiment illustrated in FIGS. 10A-10D, an annular portion 313 of the mold 301 is retained in order to stiffen the mirror film stack 312 and thereby prevent the mirror film stack 312 from buckling.

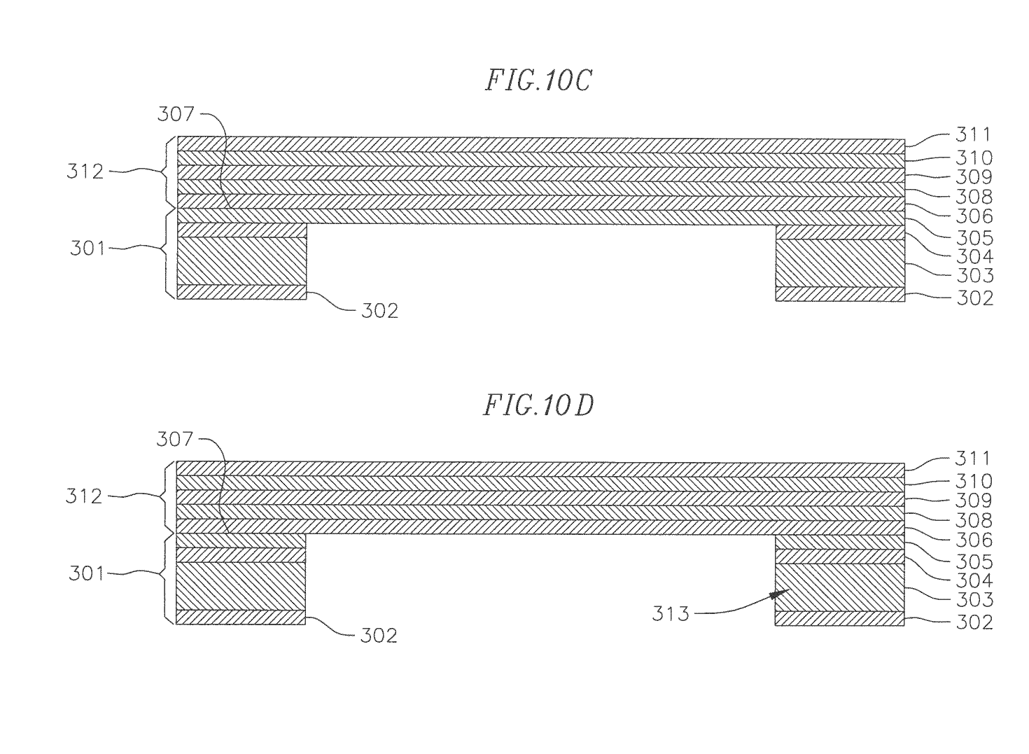

In the alternate embodiment illustrated in FIGS. 11A and 11B, separating 360 the mirror film stack 312 from the mold 301 involves a water delamination technique. In one embodiment, for example, a mirror mounting ring 314 is attached to the mirror film stack 312, and the mirror film stack 312 and mold 301 are then at least partially submerged in water. The water seeps between the mirror film stack 312 and the mold 301 by capillary action, thereby weakening the bond between the stack 312 and the mold 301 and enabling the mirror film stack 312 to be peeled away from the mold 301 to expose the base layer 306.

In yet another embodiment, separating 360 the mirror film stack 312 from the mold 301 involves subjecting the mirror film stack 312 and the mold 301 to a very low temperature. The different coefficients of thermal expansion between the mirror film stack 312 and the mold 301 facilitates removal of the mirror film stack 312 from the mold 301.

The method 300 may also include deposition, attachment or formation 365 of a reflective layer 316 on the base layer 306, such as by physical vapor deposition or electroplating. The reflective layer 316 may be deposited, attached or formed on the base layer 306 by any of the techniques described above with respect to the deposition, attachment or formation of the reflective layer 109.

While in one embodiment, the method 200, 300 of manufacturing the deformable mirror 100 may include each of the tasks or steps described above and shown in either FIG. 8 or FIG. 9, in other embodiments of the present invention, one or more of the tasks or steps described above and shown in FIGS. 8 and 9 may be absent and/or additional tasks or steps may be performed. For example, in one embodiment, the method 200, 300 of manufacturing the deformable mirror 100 may include patterning 215 the first electrode layer 106, while in another embodiment, the first electrode layer 106 may not be patterned. Furthermore, in the method 200, 300 of manufacturing the deformable mirror 100 according to one embodiment, the tasks or steps may be performed in the order depicted in either FIG. 8 or FIG. 9. However, the present invention is not limited thereto and, in a method 200, 300 of manufacturing the deformable mirror 100 according to other embodiments of the present invention, the tasks or steps described above and shown in FIG. 8 and FIG. 9 may be performed in any other suitable sequence.

With reference now to FIG. 15, an optical measurement setup 400 configured to measure the shape of a test deformable mirror 410 is schematically illustrated. The test deformable mirror 410 includes a 200 microns thick silicon wafer, a single 20 microns thick layer of P(VDF-TrFE) applied to the inner surface of the silicon wafer, and a 100 nm thick reflective gold coating applied to the outer surface of the silicon wafer. The optical measurement setup 400 includes a laser 401, a turning mirror 402, a focusing lens 403, a pinhole filter 404, a beamsplitter 405, an objective lens 406, an eyepiece lens 407, and a wavefront sensor 408. The wavefront sensor 408 utilizes an array of lenslets to form an array of spots on an image sensor. The deviation of the spots from a perfect grid is proportional to the local slope error in the wavefront. In one embodiment, a laser beam 409 projected from the laser 401 has a wavelength of approximately 633 nm. The laser beam 409 is first reflected off of the turning mirror 402 and then passed through the focusing lens 403. The laser beam 409 is then collimated by passing through the pinhole filter 404. The laser beam 409 is then split by the beamsplitter 405. One of the beams emerging from the beamsplitter 405 is passed through the eyepiece lens 407 and into the wavefront sensor 408. The other beam emerging from the beamsplitter 405 is passed through the objective lens 406, reflected off the test deformable mirror 410 and then passed to the wavefront sensor 408 by means of the beamsplitter 405 and the eyepiece lens 408. This setup arrangement reimages the mirror pupil to a smaller size that will fit inside the sensor aperture. With a good alignment of all components, the wavefront sensor 408 provides a measurement of the surface figure of the mirror 410. In one embodiment, the measurement area of the mirror 410 was constrained by the 75 mm diameter of the objective lens 406.

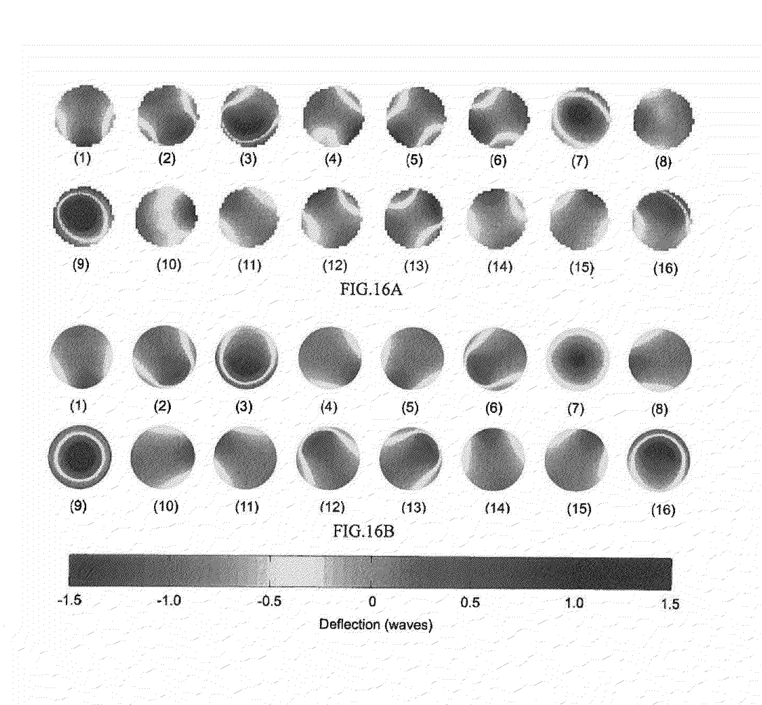

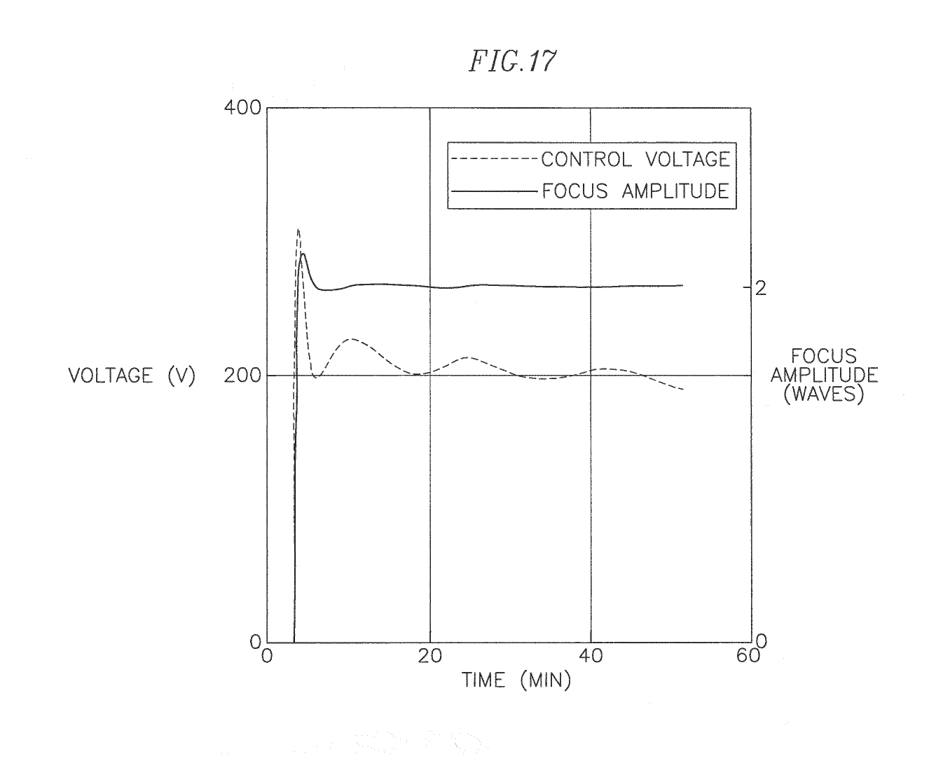

FIG. 16A illustrates the measured, individual influence functions from the various channels. These measurements were obtained by taking the difference in shape between a reference measurement with all channels off, and a new measurement with a single channel turned on and set to 400 V. FIG. 16B illustrates the corresponding predictions obtained from the finite element model.

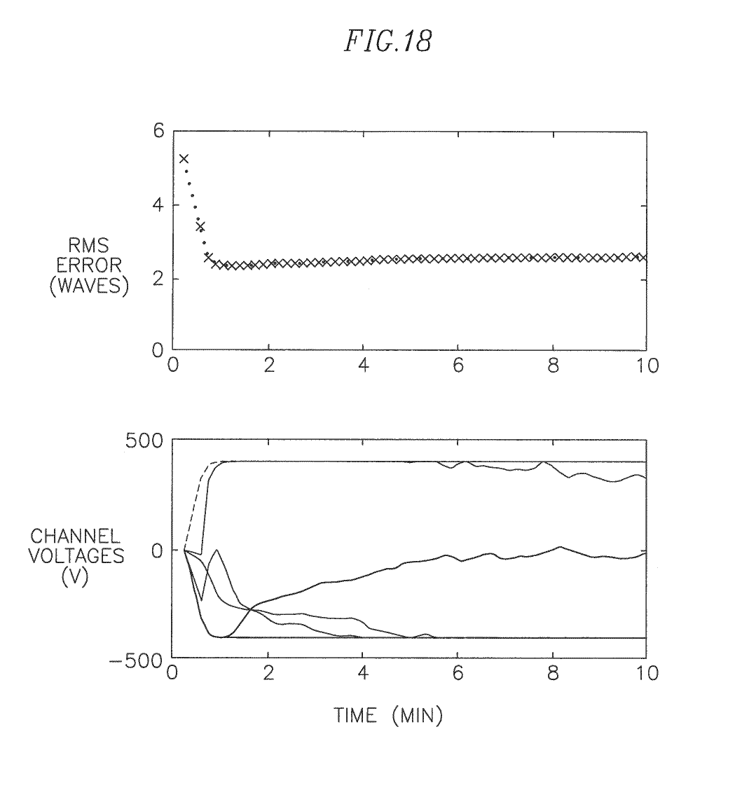

FIG. 17 illustrates the results of a test of the deformable mirror 410 having a 200 microns thick silicon wafer, a single 20 microns thick active layer of P(VDF-TrFE) applied to the inner surface of the silicon wafer, an electrode layer deposited on the active layer, and a 100 nm thick reflective gold coating applied to the outer surface of the silicon wafer. The electrode layer of the test deformable mirror 410 includes 16 semi-annular electrodes arranged in a pattern of concentric rings (see FIG. 1). The test involved using all 16 channels in the mirror 410 to correct for a defocus aberration (i.e., the axisymmetric base curvature component of the mirror surface). A simple, proportional derivative (PD) feedback controller was implemented with non-optimized gains and, for simplicity, the same voltage value was assigned to all channels. An experiment was carried out in which a step defocus change of 2 waves with a long hold was requested. The step response of the controlled mirror and the applied voltage of the controller output are illustrated in FIG. 17. Oscillations in the control voltage are due to use of a thermally unbalanced test mirror 410 and the control system compensating for changes in the uncontrolled lab thermal environment. Additionally, as illustrated in FIG. 17, after a settling period, dependent on the controller gains, the mirror defocus is controlled well within a small fraction of a wavelength.

In another test conducted on the deformable mirror 410, the lowest 66 Zernike modes were controlled with 16 independent voltages. The control algorithm was implemented by decomposing each of the 16 measured influence functions for the mirror into its Zernike components, and then implementing a PD feedback controller that reduces the magnitudes of the measured Zernike components of the actual mirror shape. At each step, the control solution was obtained by computing a constrained, least squares solution of Au=δ, and multiplying it by a factor less than unity to ensure a damped response without overshoot, and to prevent material hysteresis effects. The influence functions of the mirror were assumed to be constant and independent of voltage throughout the test. FIG. 18 illustrates the evolution of the measured RMS error during this test. The initial RMS error was 5.2 waves, which was reduced to about 2.3 waves (an improvement of about 55%) in about 4 steps. The controller was left running for about 10 minutes to verify its ability to maintain this low error. Most of the channels hit the controller limits of ±400 V, which indicates that the RMS error may be reduced further by improving the actuation stroke, such as by switching to a mirror design with a more compliant substrate, increasing the number of channels in the mirror, increasing the allowable voltage range or using optimized electrode patterns, and/or potentially by updating the influence functions.

While this invention has been described in detail with particular references to exemplary embodiments thereof, the exemplary embodiments described herein are not intended to be exhaustive or to limit the scope of the invention to the exact forms disclosed. Persons skilled in the art and technology to which this invention pertains will appreciate that alterations and changes in the described structures and methods of assembly and operation can be practiced without meaningfully departing from the principles, spirit, and scope of this invention, as set forth in the following claims. Also, although relative terms such as “outer,” “inner,” “upper,” “lower,” “below,” “above,” and similar terms have been used herein to describe a spatial relationship of one element to another, it is understood that these terms are intended to encompass different orientations of the various elements and components of the device in addition to the orientation depicted in the figures.

What is claimed is:

1. A deformable mirror, comprising:
a substrate;
a first piezoelectric active layer on a first surface of the substrate, the first piezoelectric active layer having a substantially uniform thickness across the first surface of the substrate; and
a first electrode layer on the first piezoelectric active layer, the first electrode layer having a plurality of electrodes arranged in a first pattern, the first electrode layer having a substantially uniform thickness across the first piezoelectric active layer.

2. The deformable mirror of claim 1, further comprising:
a second piezoelectric active layer on the first electrode layer; and
a second electrode layer on the second piezoelectric layer, the second electrode layer having a plurality of electrodes arranged in a second pattern.

3. The deformable mirror of claim 2, wherein the first pattern of electrodes on the first electrode layer is different than the second pattern of electrodes on the second electrode layer.

4. The deformable mirror of claim 2, wherein one of the first or second patterns comprises a triangular lattice pattern in which the plurality of electrodes are arranged in groups of three electrodes defining generally triangular shapes.

5. The deformable mirror of claim 2, wherein one of the first or second patterns comprises a tessellated pattern in which the plurality of electrodes are hexagonal in shape.

6. The deformable mirror of claim 2, wherein one of the first or second patterns comprises a concentric ring pattern in which the plurality of electrodes are semi-annular in shape.

7. The deformable mirror of claim 1, further comprising a reflective coating on a second surface of the substrate.

8. The deformable mirror of claim 1, wherein the substrate comprises a material selected from the group consisting of silicon, silicon carbide, glass, carbon fiber, aluminum, steel, and beryllium.

9. The deformable mirror of claim 1, wherein the first piezoelectric active layer comprises a material selected from the group consisting of piezoelectric polymers, piezoelectric ceramics, electrostrictive materials, dielectric elastomers, and magnetostrictives.

10. The deformable mirror of claim 1, further comprising a thermal balancing layer on a second surface of the substrate, wherein the thermal balancing layer is configured to balance the composite coefficient of thermal expansion of the deformable mirror.

11. The deformable mirror of claim 1, further comprising a microcontroller electrically coupled to each of the plurality of electrodes on the first electrode layer, wherein the plurality of electrodes are individually addressable by the microcontroller.

12. The deformable mirror of claim 1, further comprising a grounding layer disposed between the substrate and the first active layer.

13. The deformable mirror of claim 1, further comprising a stiffening rim coupled to a periphery of the substrate.

14. A method of manufacturing a deformable mirror, the method comprising:
depositing a first piezoelectric active layer on a first surface of a substrate, the first piezoelectric active layer having a substantially uniform thickness across the first surface of the substrate; and
depositing a first electrode layer on the first piezoelectric active layer, the first electrode layer having a substantially uniform thickness across the first piezoelectric active layer.

15. The method of claim 14, further comprising:
depositing a second piezoelectric active layer on the first electrode layer; and
depositing a second electrode layer on the second piezoelectric active layer.

16. The method of claim 14, wherein depositing the first piezoelectric active layer comprises spin-coating a copolymer resin on the first surface of the substrate.

17. The method of claim 14, wherein depositing the first electrode layer comprises physical vapor deposition of a conductive material on the first piezoelectric active layer.

18. The method of claim 14, wherein depositing the first electrode layer comprises patterned deposition of an electrode material on the first piezoelectric active layer.

19. The method of claim 18, wherein the patterned deposition comprises depositing a triangular lattice pattern in which the plurality of electrodes are arranged in groups of three electrodes defining generally triangular shapes.

20. The method of claim 18, wherein the electrode pattern comprises depositing a tessellated pattern in which the plurality of electrodes are hexagonal in shape.

21. The method of claim 18, wherein the electrode pattern comprises depositing a concentric ring pattern in which the plurality of electrodes are semi-annular in shape.

22. The method of claim 14, further comprising poling the first piezoelectric active layer to impart piezoelectric properties to the first active layer.

23. The method of claim 14, further comprising:
removing at least a portion of the substrate to expose at least a portion of the first active layer; and
forming a reflective layer on the exposed portion of the first active layer.

24. The method of claim 14, further comprising depositing a grounding layer between the substrate and the first piezoelectric active layer.
